(19) United States
(12) Patent Application Publication
(10) Pub. No.: US 2026/0280687 A1
(43) Pub. Date: Sep. 17, 2026

(54) Creating and Using Special Contacts for Direct-to-Cell Satellite Coverage

(71) Applicants: AT&T Mobility II LLC, Atlanta, GA (US); AT&T Intellectual Property I, L.P., Atlanta, GA (US)

(72) Inventors: Nathan Stowell, Lake Stevens, WA (US); Zhengyi Zhou, Chappaqua, NY (US); Rashmi Palamadai, Naperville, IL (US); Yupeng Jia, South Pasadena, CA (US)

(73) Assignees: AT&T Mobility II LLC, Atlanta, GA (US); AT&T Intellectual Property I, L.P., Atlanta, GA (US)

(21) Appl. No.: 19/075,880

(22) Filed: Mar. 11, 2025

(51) Int. Cl. H04B 7/185

(52) U.S. Cl. CPC H04B 7/18526; H04B 7/18532; H04B 7/18539

(57) ABSTRACT

Creating and using special contacts for direct-to-cell satellite coverage can include obtaining identity data that identifies the user device and connection data that indicates that the user device currently has limited network connectivity and is connected to a direct-to-cell satellite network connection; obtaining a record associated with the user device, the record being stored in a user database and including special contacts information that identifies a special contact for the user device. The special contact can be updated when the user device has limited network connectivity and is connected to the direct-to-cell satellite network connection. Notification preferences for the user device can be determined from a record, the preferences defining how the special contact is to be updated when the user device has limited network connectivity. Communications with a special contact device can be managed based on the notification preferences.

### BACKGROUND

Some modern computing devices such as smartphones, smartwatches, vehicle computing systems, and the like, can include multiple transceivers for conducting communications over one or more networks. At some times, tracking what network a device is communicating with can be complicated, and because network conditions can change rapidly, it may be difficult for a user to stay informed about current connections, connection statuses, and/or connection options at any given time.

### SUMMARY

The present disclosure is directed to creating and using special contacts for direct-to-cell satellite coverage. As used herein, a “special contact” can correspond to a contact (e.g., a person, a device, or the like) that a user or other entity associated with a user device has designated to receive one or more type of update regarding the network connection status of the user device. In some embodiments, a user or other entity can designate special contacts by flagging contacts in an address book, by creating special contacts using an interface, portal, or the like; and/or via other functionality. Once a special contact and/or special contact device is/are designated, the special contacts can be updated in accordance with preferences of a user or other entity associated with the user device.

In various embodiments, a user device can execute a coverage management application. The coverage management application can be configured to track network connections of the user device and can be configured to report network connection changes to a coverage management service and/or other entities and/or resources. In some embodiments, the user device can be configured to report the network connection change when the user device has limited connectivity due to connecting to a network connection provided by a direct-to-cell satellite network without having a backup network or the like. In various embodiments, the user device can capture device data that includes, but is not limited to, data defining the identity of the user device, a current network connection of the user device, and special contact information. The user device can provide the device data to the coverage management service.

The coverage management service can be configured to create a record in a user database for the user device. The record can include identity information that identifies the user device, current connection information that identifies a current network connection of the user device, special contact information that identifies one or more special contacts that is to be updated regarding a network connection status of the user device, preferences that define how communications between the user device and a special contact device are to occur during the limited connectivity of the user device, and other information.

When the coverage management service determines that the user device has limited connectivity, the coverage management service can access the record for the user device and manage communications based on the record. Thus, for example, the coverage management service can provide alerts to one or more devices (e.g., the user device, a special contact device, and/or other devices) to advise the one or more devices regarding the network connection status of the user device, to enable automatic call return functions, to enable tracking histories and/or sharing tracking histories, and the like. The coverage management service can also be configured to limit communications with the user device during the limited connectivity, in some embodiments, and to track the network connection status of the user device to determine when the user device has connected to another network connection.

According to one aspect of the concepts and technologies disclosed herein, a system is disclosed. The system can include a processor and a memory. The memory can store computer-executable instructions that, when executed by the processor, cause the processor to perform operations. The operations can include obtaining device data associated with a user device, the device data including identity data that can identify the user device and connection data that can identify a current network connection of the user device. The connection data can indicate that the user device currently has limited network connectivity and is connected to a direct-to-cell satellite network connection. The operations further can include obtaining a record associated with the user device, the record being stored in a user database and including special contacts information that can identify a special contact for the user device. The special contact can include a contact that is to be updated when the user device has limited network connectivity and is connected to the direct-to-cell satellite network connection. The operations further can include determining, based on the record associated with the user device, notification preferences associated with the user device, the notification preferences defining how the special contact is to be updated when the user device has the limited network connectivity and is connected to the direct-to-cell satellite network connection. The operations also can include managing, based on the notification preferences, communications with a special contact device associated with the special contact regarding the user device.

In some embodiments, managing the communications can include generating an alert and triggering delivery of the alert to the special contact device in response to determining that proactive alerts are to be provided to the special contact device. The alert can indicate that the user device has limited network connectivity and is connected to the direct-to-cell satellite network connection. In some embodiments, managing the communications can include generating an alert and triggering delivery of the alert to the special contact device in response to determining that the special contact device has attempted to contact the user device while the user device has the limited network connectivity and is connected to the direct-to-cell satellite network connection. The alert can indicate that the user device has the limited network connectivity and is connected to the direct-to-cell satellite network connection.

In some embodiments, managing the communications can include generating an alert and triggering delivery of the alert to the user device in response to determining that the special contact device has attempted to contact the user device while the user device has the limited network connectivity and is connected to the direct-to-cell satellite network connection. The alert can indicate that the user device has the limited network connectivity and that the special contact device has attempted to contact the user device, and the alert can include an option to automatically establish a communication between the special contact device and the user device when the user device connects to a network connection other than the direct-to-cell satellite network connection; and triggering establishment of the communication between the special contact device and the user device in response to determining that the user device has connected to the network connection other than the direct-to-cell satellite network connection.

In some embodiments, managing the communications can include obtaining, from the user device, history data that can include a first time, a first geographic location at which the user device is located, and a first indication that the user device is connected to the direct-to-cell satellite network connection; and updating the record based on the history data. In some embodiments, managing the communications can include obtaining, from the user device, history data that can include a first time, a first geographic location at which the user device is located, and a first indication that the user device is connected to the direct-to-cell satellite network connection; updating the record based on a tracking history of the user device; and in response to determining, based on the record, that the tracking history is to be shared with the special contact, sending to the special contact device a further alert with a link via which the special contact device can access the tracking history, where the tracking history can be defined by the history data. In some embodiments, operations further can include updating, at the user device, a user interface that can indicate that the user device has limited network connectivity and is connected to the direct-to-cell satellite network connection. The user interface also can include an option to share data identifying the current network connection of the user device with the special contact device.

According to another aspect of the concepts and technologies disclosed herein, a method is disclosed. The method can include obtaining device data associated with a user device, the device data including identity data that can identify the user device and connection data that can identify a current network connection of the user device. The connection data can indicate that the user device currently has limited network connectivity and is connected to a direct-to-cell satellite network connection. The method further can include obtaining a record associated with the user device, the record being stored in a user database and including special contacts information that can identify a special contact for the user device. The special contact can include a contact that is to be updated when the user device has limited network connectivity and is connected to the direct-to-cell satellite network connection. The method further can include determining, based on the record associated with the user device, notification preferences associated with the user device, the notification preferences defining how the special contact is to be updated when the user device has the limited network connectivity and is connected to the direct-to-cell satellite network connection. The method also can include managing, based on the notification preferences, communications with a special contact device associated with the special contact regarding the user device.

In some embodiments, managing the communications can include generating an alert and triggering delivery of the alert to the special contact device in response to determining that proactive alerts are to be provided to the special contact device. The alert can indicate that the user device has limited network connectivity and is connected to the direct-to-cell satellite network connection. In some embodiments, managing the communications can include generating an alert and triggering delivery of the alert to the special contact device in response to determining that the special contact device has attempted to contact the user device while the user device has the limited network connectivity and is connected to the direct-to-cell satellite network connection. The alert can indicate that the user device has the limited network connectivity and is connected to the direct-to-cell satellite network connection.

In some embodiments, managing the communications can include generating an alert and triggering delivery of the alert to the user device in response to determining that the special contact device has attempted to contact the user device while the user device has the limited network connectivity and is connected to the direct-to-cell satellite network connection. The alert can indicate that the user device has the limited network connectivity and that the special contact device has attempted to contact the user device, and the alert can include an option to automatically establish a communication between the special contact device and the user device when the user device connects to a network connection other than the direct-to-cell satellite network connection; and triggering establishment of the communication between the special contact device and the user device in response to determining that the user device has connected to the network connection other than the direct-to-cell satellite network connection.

In some embodiments, managing the communications can include obtaining, from the user device, history data that can include a first time, a first geographic location at which the user device is located, and a first indication that the user device is connected to the direct-to-cell satellite network connection; and updating the record based on the history data. In some embodiments, managing the communications can include obtaining, from the user device, history data that can include a first time, a first geographic location at which the user device is located, and a first indication that the user device is connected to the direct-to-cell satellite network connection; updating the record based on a tracking history of the user device; and in response to determining, based on the record, that the tracking history is to be shared with the special contact, sending to the special contact device a further alert with a link via which the special contact device can access the tracking history, where the tracking history can be defined by the history data. In some embodiments, operations further can include updating, at the user device, a user interface that can indicate that the user device has limited network connectivity and is connected to the direct-to-cell satellite network connection. The user interface also can include an option to share data identifying the current network connection of the user device with the special contact device.

According to yet another aspect of the concepts and technologies disclosed herein, a computer storage medium is disclosed. The computer storage medium can store computer-executable instructions that, when executed by a processor, cause the processor to perform operations. The operations can include obtaining device data associated with a user device, the device data including identity data that can identify the user device and connection data that can identify a current network connection of the user device. The connection data can indicate that the user device currently has limited network connectivity and is connected to a direct-to-cell satellite network connection. The operations further can include obtaining a record associated with the user device, the record being stored in a user database and including special contacts information that can identify a special contact for the user device. The special contact can include a contact that is to be updated when the user device has limited network connectivity and is connected to the direct-to-cell satellite network connection. The operations further can include determining, based on the record associated with the user device, notification preferences associated with the user device, the notification preferences defining how the special contact is to be updated when the user device has the limited network connectivity and is connected to the direct-to-cell satellite network connection. The operations also can include managing, based on the notification preferences, communications with a special contact device associated with the special contact regarding the user device.

In some embodiments, managing the communications can include generating an alert and triggering delivery of the alert to the special contact device in response to determining that proactive alerts are to be provided to the special contact device. The alert can indicate that the user device has limited network connectivity and is connected to the direct-to-cell satellite network connection. In some embodiments, managing the communications can include generating an alert and triggering delivery of the alert to the special contact device in response to determining that the special contact device has attempted to contact the user device while the user device has the limited network connectivity and is connected to the direct-to-cell satellite network connection. The alert can indicate that the user device has the limited network connectivity and is connected to the direct-to-cell satellite network connection.

In some embodiments, managing the communications can include generating an alert and triggering delivery of the alert to the user device in response to determining that the special contact device has attempted to contact the user device while the user device has the limited network connectivity and is connected to the direct-to-cell satellite network connection. The alert can indicate that the user device has the limited network connectivity and that the special contact device has attempted to contact the user device, and the alert can include an option to automatically establish a communication between the special contact device and the user device when the user device connects to a network connection other than the direct-to-cell satellite network connection; and triggering establishment of the communication between the special contact device and the user device in response to determining that the user device has connected to the network connection other than the direct-to-cell satellite network connection.

In some embodiments, managing the communications can include obtaining, from the user device, history data that can include a first time, a first geographic location at which the user device is located, and a first indication that the user device is connected to the direct-to-cell satellite network connection; and updating the record based on the history data. In some embodiments, managing the communications can include obtaining, from the user device, history data that can include a first time, a first geographic location at which the user device is located, and a first indication that the user device is connected to the direct-to-cell satellite network connection; updating the record based on a tracking history of the user device; and in response to determining, based on the record, that the tracking history is to be shared with the special contact, sending to the special contact device a further alert with a link via which the special contact device can access the tracking history, where the tracking history can be defined by the history data. In some embodiments, operations further can include updating, at the user device, a user interface that can indicate that the user device has limited network connectivity and is connected to the direct-to-cell satellite network connection. The user interface also can include an option to share data identifying the current network connection of the user device with the special contact device.

Other systems, methods, and/or computer program products according to embodiments will be or become apparent to one with skill in the art upon review of the following drawings and detailed description. It is intended that all such additional systems, methods, and/or computer program products be included within this description and be within the scope of this disclosure.

### BRIEF DESCRIPTION OF THE DRAWINGS

FIG. 1 is a system diagram illustrating an illustrative operating environment for various embodiments of the concepts and technologies described herein.

FIG. 2 is a flow diagram showing aspects of a method for creating records to enable special contacts for direct-to-cell satellite coverage, according to an illustrative embodiment of the concepts and technologies described herein.

FIG. 3 is a flow diagram showing aspects of a method for updating records used to manage special contacts for direct-to-cell satellite coverage, according to an illustrative embodiment of the concepts and technologies described herein.

FIG. 4A is a flow diagram showing aspects of a method for enabling communications with special contacts during direct-to-cell satellite coverage, according to an illustrative embodiment of the concepts and technologies described herein.

FIG. 4B is a flow diagram showing aspects of a method for enabling communications with special contacts during direct-to-cell satellite coverage, according to another illustrative embodiment of the concepts and technologies described herein.

FIG. 5 is a flow diagram showing aspects of a method for enabling communications with special contacts during direct-to-cell satellite coverage, according to another illustrative embodiment of the concepts and technologies described herein.

FIGS. 6A-6G are user interface diagrams showing various screen displays for providing creating and using special contacts for direct-to-cell satellite coverage, according to some illustrative embodiments of the concepts and technologies described herein.

FIG. 7 schematically illustrates a network, according to an illustrative embodiment of the concepts and technologies described herein.

FIG. 8 is a block diagram illustrating an example computer system configured to generate and provide creating and using special contacts for direct-to-cell satellite coverage, according to some illustrative embodiments of the concepts and technologies described herein.

FIG. 9 is a block diagram illustrating an example mobile device configured to interact with a coverage management service, according to some illustrative embodiments of the concepts and technologies described herein.

FIG. 10 is a diagram illustrating a computing environment capable of implementing aspects of the concepts and technologies disclosed herein, according to some illustrative embodiments of the concepts and technologies described herein.

### DETAILED DESCRIPTION

The following detailed description is directed to creating and using special contacts for direct-to-cell satellite coverage. A user device can execute a coverage management application. The coverage management application can be configured to track network connections of the user device and can be configured to report network connection changes to a coverage management service and/or other entities and/or resources. In some embodiments, the user device can be configured to report the network connection change when the user device has limited connectivity due to connecting to a network connection provided by a direct-to-cell satellite network without having a backup network or the like. In various embodiments, the user device can capture device data that includes, but is not limited to, data defining the identity of the user device, a current network connection of the user device, and special contact information. The user device can provide the device data to the coverage management service.

The coverage management service can be configured to create a record in a user database for the user device. The record can include identity information that identifies the user device, current connection information that identifies a current network connection of the user device, special contact information that identifies one or more special contacts that is to be updated regarding a network connection status of the user device, preferences that define how communications between the user device and a special contact device are to occur during the limited connectivity of the user device, and other information.

When the coverage management service determines that the user device has limited connectivity, the coverage management service can access the record for the user device and manage communications based on the record. Thus, for example, the coverage management service can provide alerts to one or more devices (e.g., the user device, a special contact device, and/or other devices) to advise the one or more devices regarding the network connection status of the user device, to enable automatic call return functions, to enable tracking histories and/or sharing tracking histories, and the like. The coverage management service can also be configured to limit communications with the user device during the limited connectivity, in some embodiments, and to track the network connection status of the user device to determine when the user device has connected to another network connection.

While the subject matter described herein is presented in the general context of program modules that execute in conjunction with the execution of an operating system and application programs on a computer system, those skilled in the art will recognize that other implementations may be performed in combination with other types of program modules. Generally, program modules include routines, programs, components, data structures, and other types of structures that perform particular tasks or implement particular abstract data types. Moreover, those skilled in the art will appreciate that the subject matter described herein may be practiced with other computer system configurations, including hand-held devices, multiprocessor systems, microprocessor-based or programmable consumer electronics, minicomputers, mainframe computers, and the like.

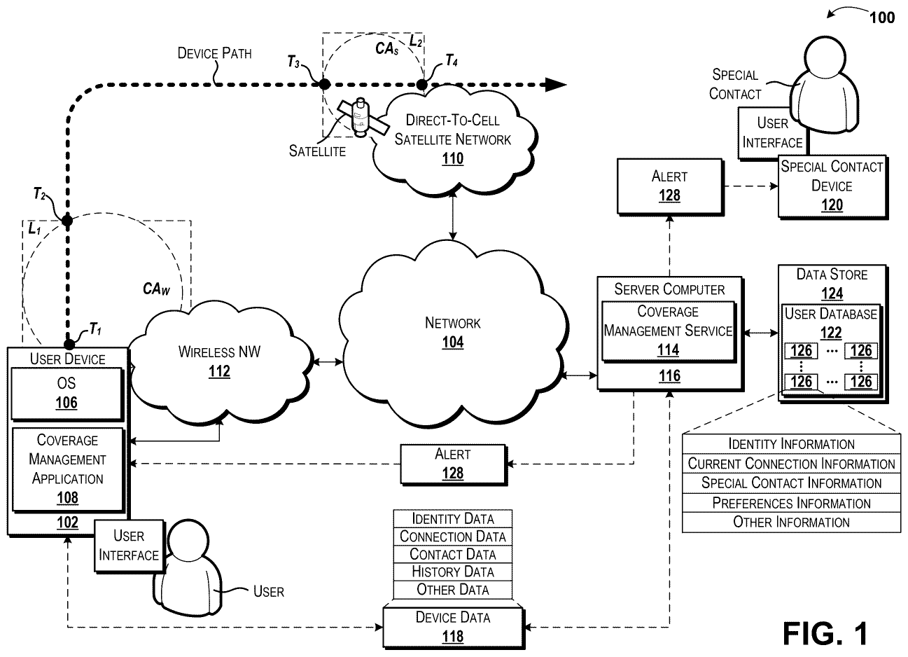

Referring now to FIG. 1, aspects of an operating environment 100 for various embodiments of the concepts and technologies disclosed herein for creating and using special contacts for direct-to-cell satellite coverage will be described, according to an illustrative embodiment. The operating environment 100 shown in FIG. 1 includes a user device 102. The user device 102 can operate in communication with and/or as part of one or more communications networks such as, for example, a communications network (“network”) 104, though this is not necessarily the case in all embodiments. As will be further explained herein, the network 104 can be accessed by one or more other networks, portals, or the like, and the user device 102 may connect to the network 104 directly, through or via these other networks, portals, or the like in various embodiments. These and other aspects of the operating environment 100 will be explained in more detail hereinbelow after introducing the various components of the operating environment 100.

According to various embodiments, the functionality of the user device 102 may be provided by one or more mobile telephones or smartphones, laptop computers, tablet computers, vehicle computing systems, other computing systems, and the like. It should be understood that the functionality of the user device 102 may be provided by a single device, by two or more similar devices, and/or by two or more dissimilar devices. For purposes of describing the concepts and technologies disclosed herein, the user device 102 is described herein as a smartphone. It should be understood that this embodiment is illustrative, and should not be construed as being limiting in any way.

The user device 102 can be configured to execute an operating system 106 and one or more application programs such as, for example, a coverage management application 108. The operating system 106 can include a computer program that can control the operation of the user device 102. The coverage management application 108 can include an executable program that can be configured to execute on top of the operating system 106 to provide various functions as illustrated and described herein for creating and using special contacts for direct-to-cell satellite coverage as illustrated and described herein.

In various embodiments, the coverage management application 108 can be configured to detect and/or manage one or more network connections of the user device 102; to update one or more entities regarding the network connections of the user device 102 (as will be illustrated and described herein in more detail below); to create, manage, and use special contacts for the user device 102; combinations thereof; or the like. In particular, as noted above, the user device 102 can be configured to connect to the network 104 directly and/or via one or more other networks or subnetworks. According to various embodiments of the concepts and technologies disclosed herein, the user device 102 can be configured to communicate with the network 104 directly and/or through a direct-to-cell satellite network 110; a cellular and/or other wireless network such as a WiFi network (hereinafter referred to as a “wireless network”) 112; a vehicle-to-vehicle network, or the like; other networks; combinations thereof; or the like.

As is generally understood, capabilities of these networks, subnetworks, and/or other networking connections (e.g., the network 104, the direct-to-cell satellite network 110, the wireless network 112, etc.) can vary in general, based on time and/or proximity of the user device 102 to hardware associated with these connections, and/or based on other factors. According to various embodiments of the concepts and technologies disclosed herein, the coverage management application 108 can be configured to create, update, and use information that indicates how the user device 102 is connected to one or more of these networks to inform designated parties or entities, referred to herein as “special contacts” and/or for other reasons as illustrated and described herein. These and other functions of the coverage management application 108 will be illustrated and described herein in more detail.

According to various embodiments, the user device 102 can be configured to connect to the wireless network 112 at a first time T₁ and while at or in proximity to a first area or location (hereinafter first location L₁) such as a home, a business, a vehicle, combinations thereof, or the like. In various embodiments, the wireless network 112 can have a wireless network coverage area CA_{W} that can correspond to a communication range in which the user device 102 can communicate with the wireless network 112 and/or hardware thereof such as a radio unit (“RU”). In various embodiments of the concepts and technologies disclosed herein, the wireless network coverage area CA_{W} can partially overlap and/or can be encompassed within the first location L₁, though this is not necessarily the case in all embodiments. As such, it should be understood that this example embodiment is illustrative, and therefore should not be construed as being limiting in any way.

The user device 102 may access the network 104 and/or other networks via the wireless network 112 at various times and/or locations including, but not limited to, the first time T₁ and first location L₁. It should be understood that this example embodiment is illustrative, and therefore should not be construed as being limiting in any way. The user device 102 also can be configured to access the wireless network 112 (e.g., a cellular network or the like) using cellular technology as is generally understood. For example, the user device 102 can be configured to communicate with the wireless network 112 to negotiate a connection and/or to be provisioned with cellular network connectivity using a cellular transceiver and/or other functionality as is generally understood. The user device 102 also can be configured to connect to the direct-to-cell satellite network 110 using its cellular transceiver and/or other hardware. It should be understood that this example embodiment is illustrative, and therefore should not be construed as being limiting in any way.

According to various embodiments of the concepts and technologies disclosed herein, the coverage management application 108 can be configured to detect one or more connections between the user device 102 and the one or more networks 104, 110, 112; to manage connections between the user device 102 and the one or more networks 104, 110, 112; to communicate with other entities to project and/or predict connections available for the user device 102; to create, update, and/or use special contacts; to update a user interface at the user device 102 to reflect current and/or future network connections and/or special contact information; to perform other functions; combinations thereof; or the like. In various embodiments, for example, the coverage management application 108 can be configured to monitor one or more transceivers and/or other hardware of the user device 102 (e.g., a WiFi transceiver, a Bluetooth transceiver, a cellular transceiver, a physical connection port, or the like) to determine and/or identify one or more network connections currently available and/or active to the user device 102. Because this information can be obtained by the coverage management application 108 in additional and/or alternative manners (e.g., reporting mechanisms, or the like), it should be understood that this example embodiment is illustrative, and therefore should not be construed as being limiting in any way. The coverage management application 108 also can be configured to report the connections of the user device 102 to one or more other entities, as will be explained in more detail herein.

As shown in FIG. 1, the user device 102 can be configured (e.g., via execution of the coverage management application 108) to communicate with a coverage management service 114. The functionality of the coverage management service 114 can be provided by an application, program, module, service, or the like, which can be hosted and/or executed by a computing device such as a server computer 116. In various embodiments, the functionality of the server computer 116 can be provided by an application server, a web server, or the like. The functionality of the server computer 116 may be provided by a single device, by two or more similar devices, and/or by two or more dissimilar devices (e.g., by a single server computer, by a cloud-based server computer, by one or more virtual resources, or the like). For purposes of describing the concepts and technologies disclosed herein, the server computer 116 is described herein as an application server. It should be understood that this example embodiment is illustrative, and therefore should not be construed as being limiting in any way.

The coverage management service 114 can be configured to identify network connections that are and/or will be available for the user device 102 at a current time and/or at one or more times in the future. In various embodiments of the concepts and technologies disclosed herein, the coverage management service 114 can determine what connection(s) are active at the user device 102 based on device data 118, which can be obtained from the user device 102 at various times. In some other embodiments, the coverage management service 114 can be configured to obtain information associated with the networks 104, 110, 112 from network monitors, network controls, reporting mechanisms, combinations thereof, or the like. As such, it should be understood that the illustrated embodiment is illustrative and therefore should not be construed as being limiting in any way. Based on the device data 118 or other information obtained by the coverage management service 114, the coverage management service 114 can be configured to identify one or more networks and/or network resources connected to by the user device 102 at any particular time. For example, as shown in FIG. 1, the user device 102 may not be stationary and may move along a device path at some times.

In particular, the user device 102 may correspond to a smartphone or an automobile computing system that moves along the device path. The user device 102 can enter and/or be located at the first location L₁ (and can be covered by the wireless network coverage area CA_{W}) at the first time T₁ and can leave the first location L₁ (and the wireless network coverage area CA_{W}) at the second time T₂. In the example embodiment shown in FIG. 1, the user device 102 may move along the device path and enter and/or be located at the second location L₂ (and covered by the satellite coverage area CA_{S} of a satellite of the direct-to-cell satellite network 110) at the third time T₃. The user device 102 can continue moving along the device path and can leave the second location L₂ (and the satellite coverage area CA_{S}) at the fourth time T₄. Thus, it can be appreciated from the example embodiment that the user device 102 may connect to the wireless network 112 from a first time T₁ until a second time T₂ and the direct-to-cell satellite network 110 from a third time T₃ until a fourth time T₄. It should be understood that this example embodiment is illustrative, and therefore should not be construed as being limiting in any way.

This connection information associated with the user device 102 can be collected by the coverage management application 108 and reported to the coverage management service 114 as part of the device data 118. The reporting of the device data 118 by the user device 102 can occur in real-time (e.g., as connections change), proactively (e.g., before the connections change), at other times, combinations thereof, or the like. According to various embodiments of the concepts and technologies disclosed herein, the device data 118 can include, but is not limited to, identity data, connection data, contact data, history data, and/or other data for and/or associated with the user device 102.

According to various embodiments of the concepts and technologies disclosed herein, the identity data can identify the device itself (e.g., the user device 102) and/or a user thereof. Thus, for example, the identity data can include, but is not limited to, a device identifier such as an International Mobile Subscriber Identity (“IMSI”), an International Mobile Equipment Identity (“IMEI”), a Permanent Equipment Identifier (“PEI”), a media access control identifier (“MAC ID”), a serial number, an Internet protocol (“IP”) address, a web identifier (“WebID”), additional and/or alternative device identifiers, combinations thereof, or the like. The identity data also can identify a user of the device (e.g., the user device 102) such as a login, name, email address, a phone number, a unique identifier, combinations thereof, or the like. Because other information can identify devices (e.g., the user device 102) and/or users thereof, it should be understood that these example embodiments are illustrative, and therefore should not be construed as being limiting in any way.

The connection data can identify, for the user device 102, one or more networks or network connections to and/or with which the device (e.g., the user device 102) is connected and/or communicates. In various embodiments of the concepts and technologies disclosed herein, the user device 102 can capture connection information by, for example, monitoring activity of one or more transceivers of the user device 102, with an active transceiver indicating that a network connection exists and/or is being used. In some embodiments, the connection data can be obtained from other entities by the user device 102 (e.g., from a network reporting device, etc.). In any case, it can be appreciated that the coverage management application 108 can be configured to collect and report the device data 118 to the coverage management service 114 in various embodiments. It should be understood that this example embodiment is illustrative, and therefore should not be construed as being limiting in any way.

The contact data can identify, for example, one or more special contacts for the user device 102. As noted above, embodiments of the concepts and technologies disclosed herein can enable a user or other entity associated with the user device 102 to designate one or more contacts (e.g., people, devices, or entities) that are to be updated on a connectivity status of the user device 102 at various times. Thus, the contact data can identify the special contacts by, for example, device identifiers and/or personal identifiers such as, for example, one or more IMSI, IMEI, PEI, MAC ID, IP address, WebID, name, telephone number, email address, login, other identifier, combinations thereof, or the like. As shown in FIG. 1, a special contact can be associated with a special contact device 120. The special contact device 120 can operate as and/or in communication with the network 104, though this is not necessarily the case in all embodiments. Though not visible in FIG. 1, it further can be appreciated that the special contact device 120 can be configured to communicate with the network 104 and/or other networks via the wireless network 112, the direct-to-cell satellite network 110, other networks, combinations thereof, or the like. It should be understood that this example embodiment is illustrative, and therefore should not be construed as being limiting in any way.

In some embodiments of the concepts and technologies disclosed herein, the functionality of the special contact device 120 may be provided by one or more mobile telephones or smartphones, laptop computers, tablet computers, vehicle computing systems, other computing systems, and the like. The functionality of the special contact device 120 may be provided by a single device, by two or more similar devices, and/or by two or more dissimilar devices. For purposes of describing the concepts and technologies disclosed herein, the special contact device 120 is described herein as a smartphone, and the special contact device 120 can execute a coverage management application 108 (not shown in FIG. 1). It should be understood that this embodiment is illustrative, and should not be construed as being limiting in any way. Thus, the contact data can include information for identifying a special contact, a device associated therewith (e.g., the special contact device 120), and the like. It should be understood that this example embodiment is illustrative, and therefore should not be construed as being limiting in any way.

The history data can include, for example, time and location records for the user device 102 (e.g., the user device 102 was located at a first geographic location at a first time). These time and location records can be used, for example, to create a digital breadcrumb trail associated with the user device 102. The digital breadcrumb trail can be used, for example, to update special contacts of the user device 102 as to the time and/or location of the user device 102, to project a time at which the user device 102 will be at another location, to prepare network resources to support the user device 102 (e.g., at a projected time and expected location, etc.), for other purposes, combinations thereof, or the like.

The other data can include, for example, contextual information obtained from the user device 102 and/or applications or services used by and/or accessed by the user device 102; location data such as a current or expected geographic location associated with the user device 102; motion data that can define motion and/or movements of the user device 102; or the like. It can be appreciated that the other data can include other information that can be used in some embodiments to project a location of the user device 102 at some time in the future and/or for other purposes. As such, it should be understood that these example embodiments are illustrative, and therefore should not be construed as being limiting in any way.

Based on the device data 118, the coverage management service 114 can be configured to create, update, maintain, and/or modify a user database 122. The user database 122 can correspond to a log of one or more users, networks, or the like that connect to one or more of the networks 104, 110, 112 and therefore can correspond, for example, to a subscriber log or file. According to various embodiments of the concepts and technologies disclosed herein, the user database 122 can be stored and/or hosted at a data store 124. The functionality of the data store 124 can be provided by one or more databases, server computers, data storage and/or host resources, other computing systems, and the like. In the illustrated embodiments, the data store 124 can be provided by a data server. In some embodiments, the data store 124 can correspond to a home subscriber server (“HSS”) and/or the like. It should be understood that this example embodiment is illustrative, and therefore should not be construed as being limiting in any way.

The user database 122 can include one or more records 126 for one or more users such as, for example, the user device 102. A record 126 for a particular device (e.g., the user device 102) can include, for example, one or more instances of identity information (e.g., a device identifier and/or user identifier) for the associated device (e.g., the user device 102); current connection information that can represent or identify one or more active network connections for the associated device (e.g., the user device 102); special contact information that can represent and/or identify one or more special contacts for the associated device (e.g., the user device 102); preferences information that can represent and/or identify one or more preferences or settings for the associated device (e.g., the user device 102); other information, combinations thereof, or the like. It can be appreciated that the user database 122 can include records for one or more, or all users associated with a particular network (e.g., the network 104, the direct-to-cell satellite network 110, the wireless network 112, or the like). Details of one example record 126 is shown as an example and should not be construed as being limiting in any way.

According to various embodiments of the concepts and technologies disclosed herein, the user database 122 and/or the records 126 associated therewith can be created and updated by the coverage management service 114. The user database 122 and/or the records 126 also can be accessed by the coverage management service 114 to identify available networks for the user device 102 (or other devices) at any time. According to various embodiments of the concepts and technologies disclosed herein, the coverage management service 114 can be configured to determine, for a device such as the user device 102, one or more network connections and/or network coverage that is or will be available to the user device 102 at some time. Based on this information, the coverage management service 114 can be configured to take various steps such as, for example, informing special contacts attempting to contact the user device 102 that the user device 102 has limited connectivity, proactively notifying the special contacts that the user device 102 has limited connectivity, making a digital breadcrumb trail for the user device 102 available to the special contacts, combinations thereof, or the like, as will be illustrated and described in more detail hereinbelow.

According to various embodiments of the concepts and technologies disclosed herein, the coverage management service 114 can be configured receive or otherwise obtain device data 118 from the user device 102. It can be appreciated that the device data 118 can be provided to the server computer 116 at various times. In some embodiments, the user device 102 can provide the device data 118 to the server computer 116 when a network connection of the user device 102 changes. In some other embodiments, the user device 102 can provide the device data 118 to the server computer 116 at regular intervals. In yet other embodiments, the user device 102 can provide the device data 118 to the server computer 116 when requested by the server computer 116 or other device or entity. In still other embodiments, the user device 102 can provide the device data 118 to the server computer 116 when a user or other entity of the user device 102 enters a command or option to provide the device data 118 to the server computer 116. Because the user device 102 can provide the device data 118 at additional and/or alternative times, it should be understood that these example embodiments are illustrative, and therefore should not be construed as being limiting in any way.

In some embodiments, the server computer 116 can be configured (e.g., via execution of the coverage management service 114) to receive or otherwise obtain the device data 118. The coverage management service 114 can analyze the device data 118 to determine an identity associated with the device data 118 (e.g., a user, device, or the like such as the user device 102 and/or a user associated therewith); to obtain preferences for creation and/or management of special contacts for the user device 102; to identify one or more special contacts represented by the device data 118 (if included); to determine one or more alert options specified for the one or more special contacts (if included); to determine a current network status of the user device 102 (e.g., what network the user device 102 is currently connected to); combinations thereof; or the like. The coverage management service 114 can use these and/or other types of information included in the device data 118 to create and store a record 126 associated with the user device 102. As mentioned above, the record 126 can be stored in a user database 122 stored at a data store 124 in some embodiments. Thus, it can be appreciated that the server computer 116 can be configured (e.g., via execution of the coverage management service 114) to create the records 126 illustrated and described herein. It should be understood that this example embodiment is illustrative, and therefore should not be construed as being limiting in any way.

In some embodiments, the server computer 116 also can be configured (e.g., via execution of the coverage management service 114) to receive or otherwise obtain the device data 118. The coverage management service 114 can analyze the device data 118 to determine an identity associated with the device data 118 (e.g., a user, device, or the like such as the user device 102 and/or a user associated therewith) and to determine if a record 126 for the identity exists (e.g., in the user database 122). The server computer 116 can obtain the record 126 associated with the identity and determine (from analysis of the device data 118), a current network connection for the user device 102. The server computer 116 can update the record 126 with the current network connection for the user device 102 and determine, based on the device data 118, if the user device 102 is currently connected to a satellite associated with the direct-to-cell satellite network 110. In some embodiments, the connectivity provided by the direct-to-cell satellite network 110 may be limited in terms of latency, bandwidth, other functionality, and the like. Thus, the server computer 116 can be configured to determine if the user device 102 is connected to the direct-to-cell satellite network 110 for these and other reasons.

If the server computer 116 determines that the user device 102 is currently connected to the direct-to-cell satellite network 110, the server computer 116 can determine if the user device 102 has designated and/or defined one or more special contact. It can be appreciated that the server computer 116 can make this determination by analyzing the record 126 and determining if one or more special contact has been specified and/or defined. If the server computer 116 determines that one or more special contact has been designated and/or defined, the server computer 116 can manage communications with the special contacts. In particular the server computer 116 can provide proactive alerts 128 to the special contacts (e.g., devices used by the special contacts such as the special contact device 120, or the like), provide an alert 128 to a special contact when a connection is attempted, capture a digital breadcrumb trail and make that available to the special contacts, combinations thereof, or the like.

In some embodiments, the server computer 116 can manage the communications with the one or more special contacts by determining notification preferences for the one or more special contacts. The server computer 116 can determine the preferences for the one or more special contacts by analyzing the record 126 associated with the user device 102 and determining, based on the record 126, if proactive alerts 128 are to be provided to the one or more special contacts. If the server computer 116 determines, based on the record 126, that proactive alerts 128 are to be provided to the one or more special contacts, the server computer 116 can generate (e.g., create and deliver) the one or more alerts 128 or trigger the delivery of the alerts 128 by other entities or resources. In some embodiments, the alerts 128 can inform the user device 102 that connectivity is limited, that special contacts are to be informed of the limited connectivity (and/or to obtain approval for delivery of alerts 128), and the like. The server computer 116 also can determine if a special contact (e.g., via the special contact device 120) has tried to contact the user device 102. If the server computer 116 determines that a special contact (e.g., via the special contact device 120) has tried to contact the user device 102, the server computer 116 can determine (e.g., based on analysis of preferences included in the record 126 for the user device 102), if a follow-up call is requested. A follow-up call can correspond to a call or connection that can be established when the user device 102 reconnects to a network for which connectivity of the user device 102 is not as limited as on a current network (namely, the direct-to-cell satellite network 110) to which the user device 102 is connected.

If the server computer 116 determines that the follow-up call is requested, the server computer 116 can track status of the user device 102. In some embodiments, the server computer 116 can monitor the record 126 associated with the user device 102 for changes to the network connection of the user device 102, for example. The server computer 116 can continue tracking the status of the user device 102 until the server computer 116 determines that a network connection of the user device 102 has changed, e.g., that the user device 102 is no longer connected to the direct-to-cell satellite network 110 and/or that the user device 102 has connected to another network (e.g., the wireless network 112). When the server computer 116 determines that a network connection of the user device 102 has changed, e.g., that the user device 102 is no longer connected to the direct-to-cell satellite network 110 and/or that the user device 102 has connected to another network (e.g., the wireless network 112), the server computer 116 can connect the special contact (e.g., the special contact device 120) to the user device 102.

In some embodiments, the server computer 116 can manage the communications with the one or more special contacts by determining notification preferences for the one or more special contacts. The server computer 116 can determine the preferences for the one or more special contacts by analyzing the record 126 associated with the user device 102 and determining, based on the record 126, if a tracking history (e.g., tracking and/or creating a digital breadcrumb trail for the user device 102) is enabled for the user device 102. If the server computer 116 determines, based on the record 126, that the tracking history is enabled for the user device 102, the server computer 116 can instruct the user device 102 to provide history data to the server computer 116 (e.g., as part of the device data 118). The server computer 116 can obtain the history data (which can include a network connection for the user device 102 at a particular time) and update the record 126 associated with the user device 102. The server computer 116 also can determine if the tracking history associated with the user device 102 is to be shared with one or more special contact.

If the server computer 116 determines that the tracking history is to be shared with one or more special contact (e.g., via the special contact device 120), the server computer 116 can notify the special contact device 120 (e.g., via an alert 128) that the tracking history is available, and the special contact device 120 can access the tracking history via a portal or the like. The tracking history can include datapoints that can include, but are not limited to, a time, a geographic location of the user device 102 at the time, and network connection of the user device 102 at the time. It should be understood that this example embodiment is illustrative, and therefore should not be construed as being limiting in any way.

The server computer 116 can track status of the user device 102. In some embodiments, the server computer 116 can monitor the record 126 associated with the user device 102 for changes to the network connection of the user device 102, for example, to determine the status of the network connection of the user device 102. The server computer 116 can continue tracking the status of the user device 102 until the server computer 116 determines that a network connection of the user device 102 has changed, e.g., that the user device 102 is no longer connected to the direct-to-cell satellite network 110 and/or that the user device 102 has connected to another network (e.g., the wireless network 112). When the server computer 116 determines that a network connection of the user device 102 has changed, e.g., that the user device 102 is no longer connected to the direct-to-cell satellite network 110 and/or that the user device 102 has connected to another network (e.g., the wireless network 112), the server computer 116 can end the tracking of the status of the user device 102.

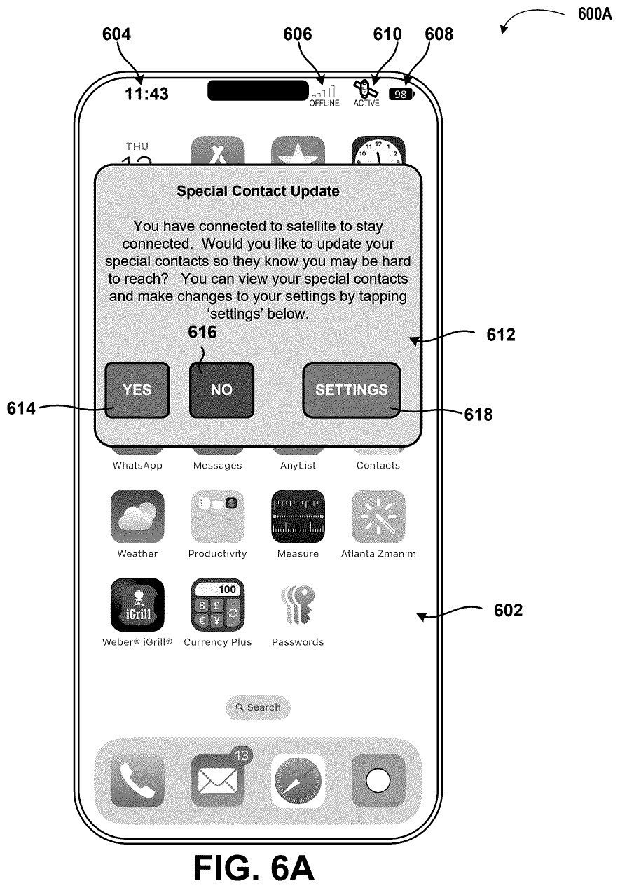

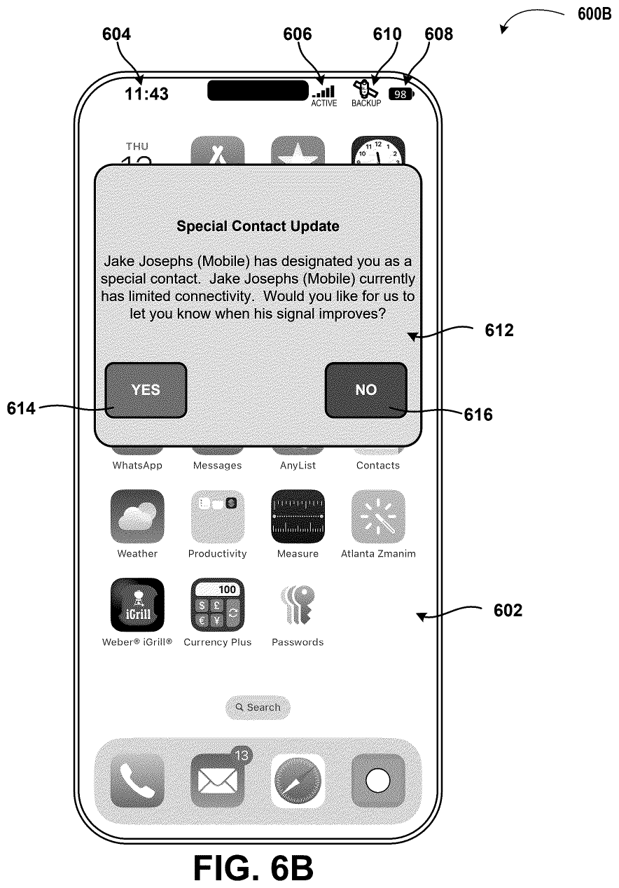

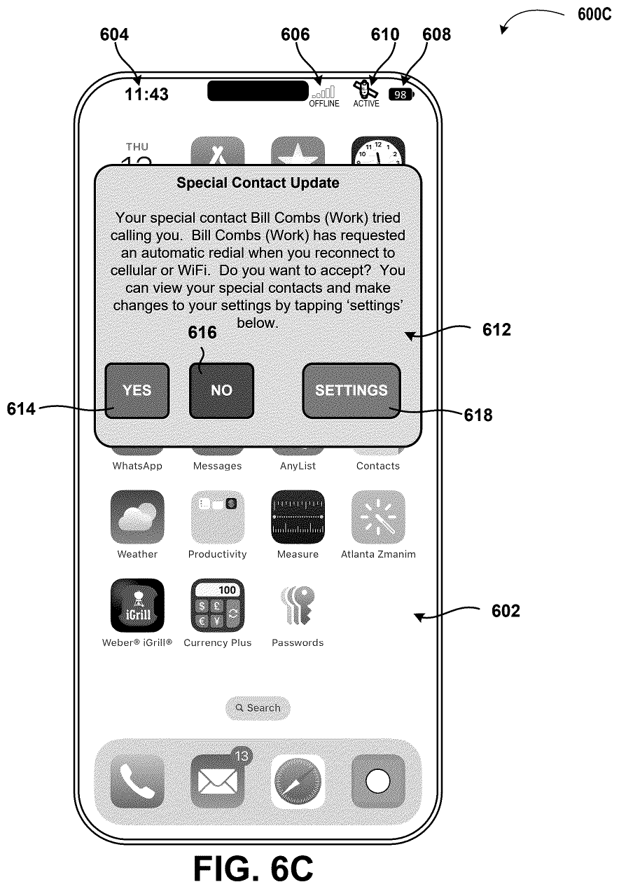

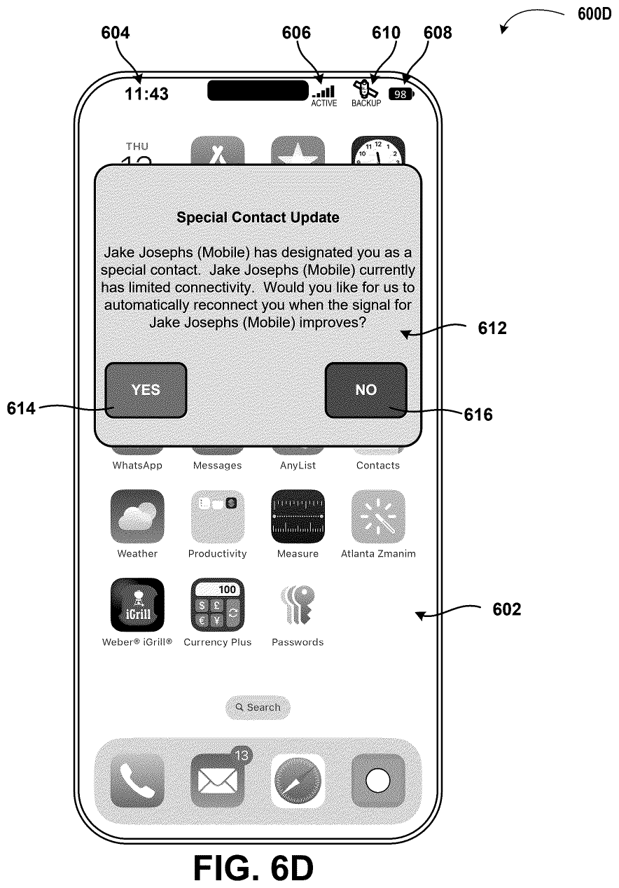

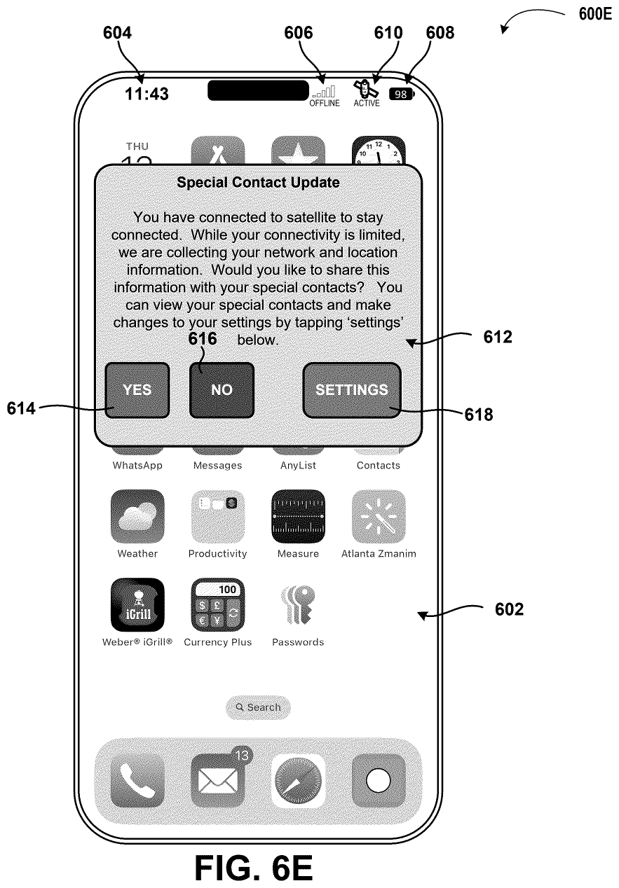

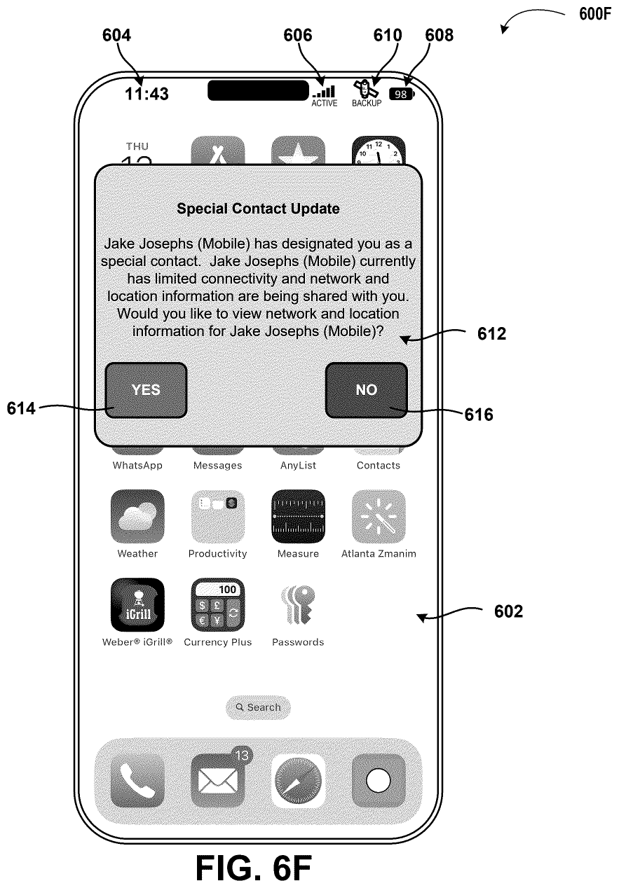

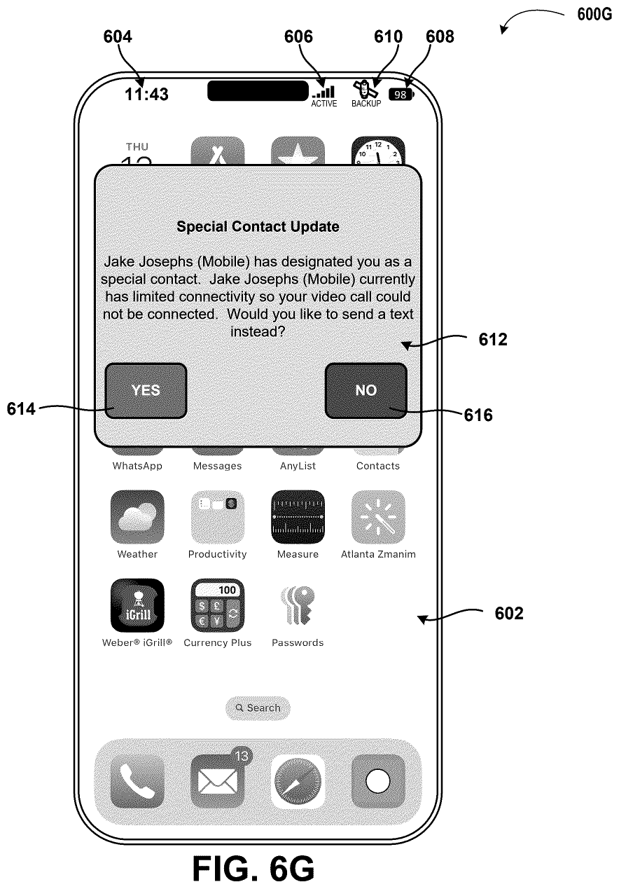

According to various embodiments of the concepts and technologies disclosed herein, the user device 102 and/or the special contact device 120 can be configured, for example via executing the coverage management application 108, to generate a user interface and/or user interface elements based on the alerts 128. Thus, for example, the user device 102 can generate a user interface for display at the user device 102, where the user interface can indicate that the user device 102 is connected to a direct-to-cell satellite connection and that the network connection of the user device 102 has limited connectivity as a result. The user interface can also provide options for informing special contacts (or not informing special contacts); enabling, disabling, and/or sharing a tracking history for the user device 102; and/or other options as illustrated and described herein. Some example user interfaces are illustrated and described herein with reference to FIGS. 6A-6G. It should be understood that these example embodiments are illustrative, and therefore should not be construed as being limiting in any way.

In practice, a user device 102 can execute a coverage management application 108. The coverage management application 108 can be configured to track network connections of the user device 102 and can be configured to report network connection changes to a coverage management service 114 and/or other entities and/or resources. In some embodiments, the user device 102 can be configured to report the network connection change when the user device 102 has limited connectivity due to connecting to a network connection provided by a direct-to-cell satellite network 110 without having a backup network or the like. In various embodiments, the user device 102 can capture device data 118 that includes, but is not limited to, data defining the identity of the user device 102, a current network connection of the user device 102, and special contact information. The user device 102 can provide the device data 118 to the coverage management service 114.

The coverage management service 114 can be configured to create a record 126 in a user database 122 for the user device 102. The record 126 can include identity information that identifies the user device 102, current connection information that identifies a current network connection of the user device 102, special contact information that identifies one or more special contacts that is to be updated regarding a network connection status of the user device 102, preferences that define how communications between the user device 102 and a special contact device 120 are to occur during the limited connectivity of the user device 102, and other information.

When the coverage management service 114 determines that the user device 102 has limited connectivity, the coverage management service 114 can access the record 126 for the user device 102 and manage communications based on the record 126. Thus, for example, the coverage management service 114 can provide alerts 128 to one or more devices (e.g., the user device 102, a special contact device 120, and/or other devices) to advise the one or more devices regarding the network connection status of the user device 102, to enable automatic call return functions, to enable tracking histories and/or sharing tracking histories, and the like. The coverage management service 114 can also be configured to limit communications with the user device 102 during the limited connectivity, in some embodiments, and to track the network connection status of the user device 102 to determine when the user device 102 has connected to another network connection.

FIG. 1 illustrates one user device 102, one network 104, one direct-to-cell satellite network 110 having one satellite, one wireless network 112, one server computer 116, one special contact device 120, and one data store 124. It should be understood, however, that various implementations of the operating environment 100 can include one or more than one user device 102; one or more than one network 104; one or more than one direct-to-cell satellite network 110 (one or more of which may have one or more than one satellite); one or more than one wireless network 112; one or more than one server computer 116; one or more than one special contact device 120; and/or zero, one, or more than one data store 124. As such, the illustrated embodiment should be understood as being illustrative, and should not be construed as being limiting in any way.

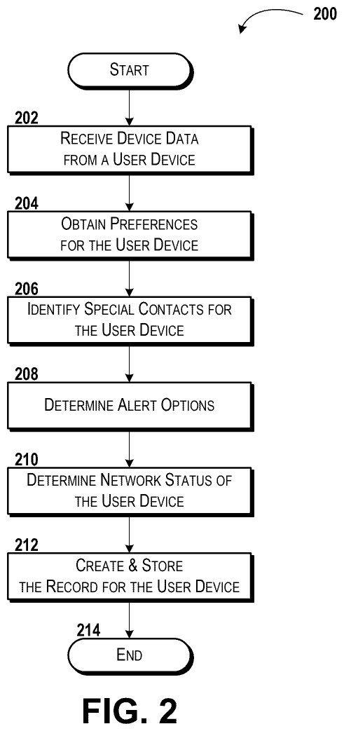

Turning now to FIG. 2, aspects of a method 200 for creating records 126 to enable special contacts for direct-to-cell satellite coverage will be described in detail, according to an illustrative embodiment. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the concepts and technologies disclosed herein.

It also should be understood that the methods disclosed herein can be ended at any time and need not be performed in its entirety. Some or all operations of the methods, and/or substantially equivalent operations, can be performed by execution of computer-readable instructions included on a computer storage media, as defined herein. The term “computer-readable instructions,” and variants thereof, as used herein, is used expansively to include routines, applications, application modules, program modules, programs, components, data structures, algorithms, and the like. Computer-readable instructions can be implemented on various system configurations including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These states, operations, structural devices, acts, and modules may be implemented in software, in firmware, in special purpose digital logic, and any combination thereof. As used herein, the phrase “cause a processor to perform operations” and variants thereof is used to refer to causing a processor of a computing system or device, such as the user device 102 and/or the server computer 116 to perform one or more operations and/or causing the processor to direct other components of the computing system or device to perform one or more of the operations.

For purposes of illustrating and describing the concepts of the present disclosure, the method 200 is described herein as being performed by the server computer 116 via execution of one or more software modules such as, for example, the coverage management service 114. It should be understood that additional and/or alternative devices and/or network nodes can provide the functionality described herein via execution of one or more modules, applications, and/or other software including, but not limited to, the coverage management service 114. Thus, the illustrated embodiments are illustrative, and should not be viewed as being limiting in any way.

The method 200 begins at operation 202. At operation 202, the server computer 116 can receive device data 118 from the user device 102. According to various embodiments of the concepts and technologies disclosed herein, the user device 102 can be configured to send the device data 118 to the server computer 116 when a network connection change is detected at the user device 102, at time intervals, on request from the server computer 116 and/or other entities, or the like. In some embodiments, the user device 102 can be configured to create and send the device data 118 to the server computer 116 under limited circumstances. In particular, the user device 102 can be configured, in some embodiments, to send the device data 118 to the server computer 116 only when the user device 102 detects the establishment of a connection with a direct-to-cell satellite network 110 with limited or no backup network connection, or when the user device 102 detects that a new network connection has been established as a primary or backup network after previously being connected only to a direct-to-cell satellite network 110 with limited or no backup network connection. Because the device data 118 can be provided to the server computer 116 in additional and/or alternative circumstances, it should be understood that these example embodiments are illustrative, and therefore should not be construed as being limiting in any way.

From operation 202, the method 200 can proceed to operation 204. At operation 204, the server computer 116 can obtain preferences for the user device 102. The server computer 116 can be configured to analyze the device data 118 obtained in operation 202 to determine, for the user device 102, one or more preferences defined for communications with one or more special contacts. Thus, the preferences obtained in operation 204 can correspond to how alerts 128 are generated for the one or more special contact (e.g., if the alerts 128 are proactively generated or generated on-demand, etc.), how tracking history is enabled for the user device 102, to whom the tracking history is made available, combinations thereof, or the like. Thus, operation 204 can correspond to the server computer 116 analyzing the device data 118 to identify preferences for the user device 102. It should be understood that this example embodiment is illustrative, and therefore should not be construed as being limiting in any way.

From operation 204, the method 200 can proceed to operation 206. At operation 206, the server computer 116 can identify special contacts for the user device 102. In operation 206, the server computer 116 can analyze the device data 118 to identify one or more special contact designated by the user device 102. The server computer 116 can identify contact information for the special contact (e.g., an email address, a telephone number, an IP address, or the like) and any other information that can be used to identify the special contact. It can be appreciated that a special contact can be created at the user device 102 by flagging contacts in a contact book, by entering contact information in a form or other user interface, and/or in other ways. Thus, operation 206 can correspond to the server computer 116 determining the special contacts from the device data 118. It should be understood that this example embodiment is illustrative, and therefore should not be construed as being limiting in any way.

From operation 206, the method 200 can proceed to operation 208. At operation 208, the server computer 116 can determine alert options for the one or more special contacts identified in operation 206. According to various embodiments of the concepts and technologies disclosed herein, the user device 102 can specify how alerts 128 are provided to the one or more special contacts. For example, the user device 102 can specify if proactive alerts 128 relating to status of the user device 102 are or are not to be provided, if on-demand alerts 128 relating to status of the user device 102 (e.g., network connectivity status when the special contact device 120 attempts to connect to the user device 102) are or are not to be provided, and the like. Thus, operation 208 can correspond to the server computer 116 determining, based on the device data 118, one or more alert options for the one or more special contacts. It should be understood that this example embodiment is illustrative, and therefore should not be construed as being limiting in any way.

From operation 208, the method 200 can proceed to operation 210. At operation 210, the server computer 116 can determine a network status of the user device 102. In operation 210, the server computer 116 can analyze the device data 118 to determine what network connections exist for the user device 102 at a current time. According to various embodiments, as explained herein, the user device 102 can be configured to provide the device data 118 when a network connection of the user device 102 changes and/or at other times. Thus, the device data 118 can include a current network connection of the user device 102 and the server computer 116 can determine, based on analysis of the device data 118, the current network connection of the user device 102.

In one contemplated example embodiment, for example, the server computer 116 may determine in operation 210 that the user device 102 is currently connected to a direct-to-cell satellite network 110 with no backup connection. In another contemplated example embodiment, for example, the server computer 116 may determine in operation 210 that the user device 102 is currently connected to a direct-to-cell satellite network 110 with a limited backup connection. In either event, the server computer 116 may determine that the user device 102 currently has a network connection with limited connectivity. It should be understood that this example embodiment is illustrative, and therefore should not be construed as being limiting in any way. It can be appreciated that the server computer 116 can determine in operation 210 that the user device 102 has a network connection that does not have limited connectivity. As such, it should be understood that the example embodiments in which limited connectivity is detected are illustrative and should not be construed as being limiting in any way.

From operation 210, the method 200 can proceed to operation 212. At operation 212, the server computer 116 can create and store the record 126 for the user device 102. The server computer 116 can create the record 126 for the user device 102 by adding data to the user database 122. As shown in FIG. 1, the server computer 116 can create the record 126 with identity information that identifies the user device 102 and/or a user thereof, current connection information that identifies a current network connection of the user device 102, special contact information that identifies and/or defines one or more special connection for the user device 102, preferences information that identifies and/or defines one or more preferences for the user device 102 and/or a user thereof for managing communications with the special contacts. Thus, operation 212 can correspond to the server computer 116 creating a data file and storing the data file at the data store 124 and/or adding data to the user database 122. Because the record 126 can be created in additional and/or alternative manners, it should be understood that these example embodiments are illustrative, and therefore should not be construed as being limiting in any way.

From operation 212, the method 200 can proceed to operation 214. The method 200 can end at operation 214.

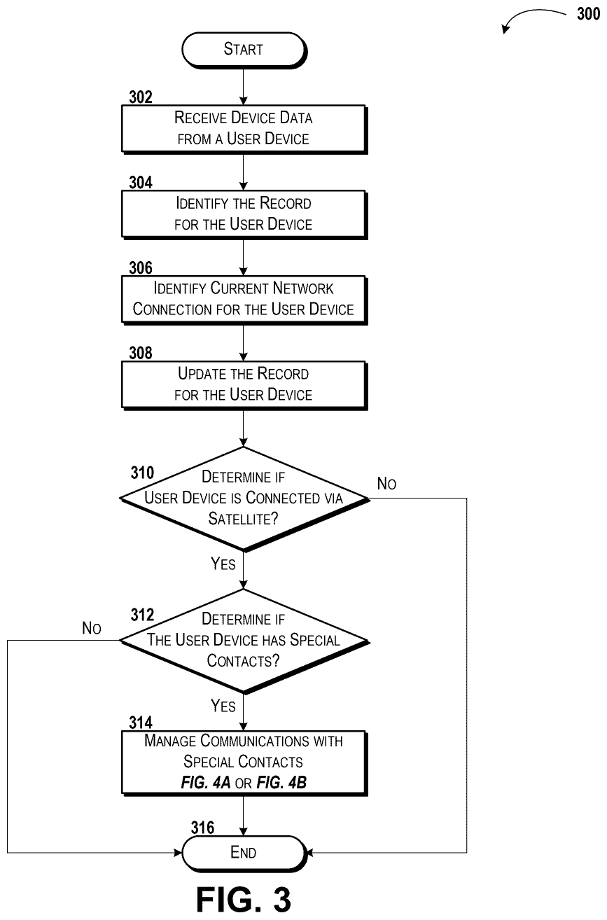

Turning now to FIG. 3, aspects of a method 300 for updating records 126 used to manage special contacts for direct-to-cell satellite coverage will be described in detail, according to an illustrative embodiment. For purposes of illustrating and describing the concepts of the present disclosure, the method 300 is described herein as being performed by the server computer 116 via execution of one or more software modules such as, for example, the coverage management service 114. It should be understood that additional and/or alternative devices and/or network nodes can provide the functionality described herein via execution of one or more modules, applications, and/or other software including, but not limited to, the coverage management service 114. Thus, the illustrated embodiments are illustrative, and should not be viewed as being limiting in any way.

The method 300 begins at operation 302. At operation 302, the server computer 116 can receive device data 118 from the user device 102. As explained herein, the user device 102 can be configured to send the device data 118 to the server computer 116 when a network connection change is detected at the user device 102, at time intervals, when requested by the server computer 116 and/or other entities, when the user device 102 detects certain network connection changes (e.g., connection to or disconnection from the direct-to-cell satellite network 110, when no backup connection exists, when bandwidth and/or latency drops below a defined threshold, combinations thereof, or the like), combinations thereof, or the like.

In some embodiments, the user device 102 can be configured to create and send the device data 118 to the server computer 116 when the user device 102 detects the establishment of a connection with a direct-to-cell satellite network 110 with limited or no backup network connection, or when the user device 102 detects that a new network connection has been established as a primary or backup network after previously being connected only to a direct-to-cell satellite network 110 with limited or no backup network connection. Because the device data 118 can be provided to the server computer 116 in additional and/or alternative circumstances, it should be understood that these example embodiments are illustrative, and therefore should not be construed as being limiting in any way.

From operation 302, the method 300 can proceed to operation 304. At operation 304, the server computer 116 can identify a record 126 for the user device 102. It can be appreciated that in some embodiments, the server computer 116 can identify the record 126 for the user device 102 based on identity information that can be included in the record 126 and identify data included in the device data 118, for example. Because the record 126 associated with the user device 102 can be identified in additional and/or alternative manners, it should be understood that this example embodiment is illustrative, and therefore should not be construed as being limiting in any way. Regardless of how the record 126 is identified, the server computer 116 can identify the record 126 for the user device 102 and, in some embodiments, retrieve and/or access the record 126 for other operations of the method 300. It should be understood that this example embodiment is illustrative, and therefore should not be construed as being limiting in any way.

From operation 304, the method 300 can proceed to operation 306. At operation 306, the server computer 116 can analyze the device data 118 to determine a current network connection for the user device 102. Although not illustrated separately in FIG. 3, it can be appreciated that the server computer 116 can be configured to determine if the network connection of the user device 102 has changed (e.g., if the current network connection indicated in the device data 118 differs from the network connection represented by the record 126 associated with the user device 102). Because in some embodiments of the concepts and technologies disclosed herein, the device data 118 may be generated by the user device 102 only when network connection changes are detected by the user device 102, it can be appreciated that in some embodiments, checking for changes may be unnecessary. It should be understood that this example embodiment is illustrative, and therefore should not be construed as being limiting in any way. At any rate, the server computer 116 can detect a change to the network connection of the user device 102 and/or can assume that a change has occurred. In any event, the server computer 116 can determine, based on the device data 118, the current network connection of the user device 102. It should be understood that this example embodiment is illustrative, and therefore should not be construed as being limiting in any way.

From operation 306, the method 300 can proceed to operation 308. At operation 308, the server computer 116 can update the record 126 for the user device 102. Thus, it can be appreciated that the server computer 116 can be configured to update the record 126, thereby ensuring that the user database 122 can reflect, at any given time, a most-recently-determined network connection for the user device 102. It should be understood that this example embodiment is illustrative, and therefore should not be construed as being limiting in any way.

From operation 308, the method 300 can proceed to operation 310. At operation 310, the server computer 116 can determine if the user device 102 is connected (e.g., to the network 104 or other network) via a satellite associated with a direct-to-cell satellite network 110. Thus, operation 310 can correspond to the server computer 116 determining if the user device 102 is currently connected to the direct-to-cell satellite network 110. Although not illustrated separately in FIG. 3, it should be understood that the server computer 116 may determine, in operation 310, not only if the user device 102 is connected to the direct-to-cell satellite network 110, but also if the user device 102 has no backup network connection. In particular, embodiments of the concepts and technologies disclosed herein are provided to address situations in which the network connection of the user device 102 has limited connectivity. Thus, determining that the user device 102 is connected to the direct-to-cell satellite network 110 in operation 310 can correspond to the server computer 116 determining if the user device 102 is connected to the direct-to-cell satellite network 110 without another network connection and/or without a network connection that provides improved connectivity over the direct-to-cell satellite network connection to the direct-to-cell satellite network 110. It should be understood that this example embodiment is illustrative, and therefore should not be construed as being limiting in any way.

If the server computer 116 determines, in operation 310, that the user device 102 is connected (e.g., to the network 104 or other network) via a satellite associated with a direct-to-cell satellite network 110, the method 300 can proceed to operation 312. At operation 312, the server computer 116 can determine if the user device 102 has special contacts and/or that one or more special contact associated with the user device 102 has been defined by the user device 102 and/or authorized entities associated therewith. Operation 312 can correspond to the server computer 116 determining, by analyzing the record 126 associated with the user device 102, if contact information for special contacts is represented by the record 126.

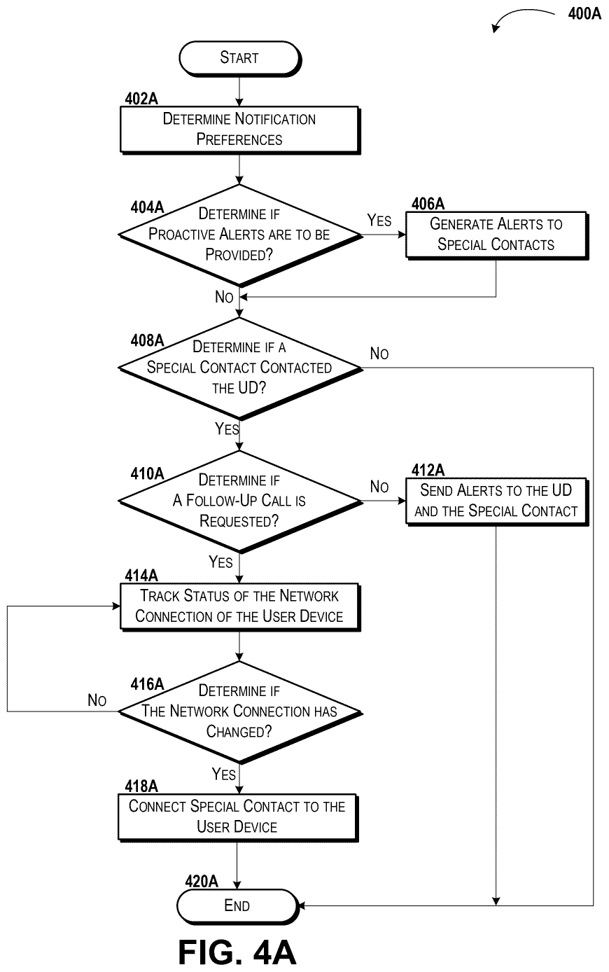

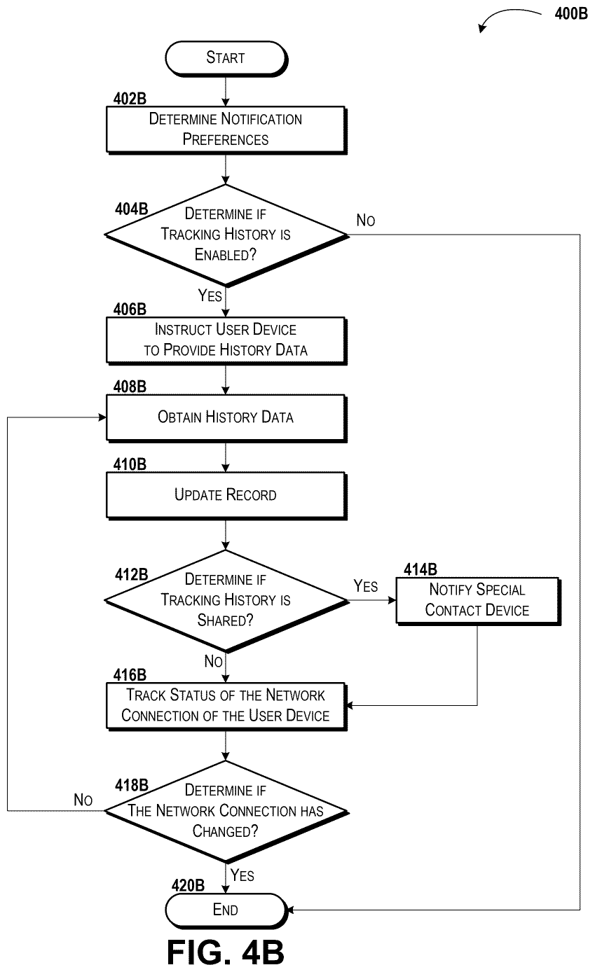

If the server computer 116 determines, in operation 312, that the user device 102 has associated special contacts, the method 300 can proceed to operation 314. At operation 314, the server computer 116 can manage communications with special contact. Operation 314 can correspond to the server computer 116 applying communication preferences, alerts, and the like to communications between the user device 102 and the special contacts (e.g., the special contact device 120), as will be illustrated and described in more detail hereinbelow with reference to FIGS. 4A-4B. It should be understood that this example embodiment is illustrative, and therefore should not be construed as being limiting in any way.

From operation 314, the method 300 can proceed to operation 316. The method 300 also can proceed to operation 316 from operation 310 if the server computer 116 determines, in operation 310, that that the user device 102 is not connected (e.g., to the network 104 or other network) via a satellite associated with a direct-to-cell satellite network 110 (or that the user device 102 is connected via a satellite associated with a direct-to-cell satellite network 110 but has an available backup connection that does not have limited connectivity to the extent that the direct-to-cell satellite network 110 has). The method 300 also can proceed to operation 316 if the server computer 116 determines, in operation 312, that the user device 102 does not have any associated special contacts (e.g., no special contacts have been defined for the user device 102). The method 300 can end at operation 316.

Turning now to FIG. 4A, aspects of a method 400A for enabling communications with special contacts during direct-to-cell satellite coverage will be described in detail, according to an illustrative embodiment. For purposes of illustrating and describing the concepts of the present disclosure, the method 400A is described herein as being performed by the server computer 116 via execution of one or more software modules such as, for example, the coverage management service 114. It should be understood that additional and/or alternative devices and/or network nodes can provide the functionality described herein via execution of one or more modules, applications, and/or other software including, but not limited to, the coverage management service 114. Thus, the illustrated embodiments are illustrative, and should not be viewed as being limiting in any way.

It can be appreciated with reference to FIG. 3 that the functionality of the method 400 illustrated in FIG. 4A can be performed, in some embodiments, by the server computer 116 in operation 314 of the method 300 illustrated in FIG. 3. It should be understood, however, that the functionality of the method 400A illustrated and described herein can be performed by the server computer 116 at additional and/or alternative times. Thus, it should be understood that the illustrated example embodiment is illustrative, and therefore should not be construed as being limiting in any way.

The method 400A begins at operation 402A. At operation 402A, the server computer 116 can determine notification preferences for the user device 102. It can be appreciated that in operation 402A, the record 126 may already have been retrieved by the server computer 116 (e.g., in operation 304 of the method 300 illustrated in FIG. 3). It should be understood, however, that operation 402A can include the server computer 116 retrieving the record 126 for the user device 102 in some embodiments. In any event, the server computer 116 can analyze the record 126 and determine how notifications (e.g., alerts 128 and the like) are to be generated for the special contacts associated with the user device 102. Because notification preferences can be determined by the server computer 116 in additional and/or alternative manners (e.g., receiving the notification preferences from other devices, settings, or the like), it should be understood that this example embodiment is illustrative, and therefore should not be construed as being limiting in any way.

From operation 402A, the method 400A can proceed to operation 404A. At operation 404A, the server computer 116 can determine if proactive alerts 128 are to be provided to special contacts of the user device 102. As used herein, “proactive alerts” can be used to refer to alerts 128 that can be provided to one or more devices (e.g., the user device 102 and the special contact device 120) when a limited connectivity connection for the user device 102 is detected (e.g., when the user device 102 connects to a direct-to-cell satellite connection provided by the direct-to-cell satellite network 110). A proactive alert 128 can inform a special contact device 120 and/or the user device 102 about the limited connectivity of the user device 102 to attempt to limit connection attempts with the user device 102. Thus, operation 404A can correspond to the server computer 116 determining if a user associated with the user device 102 as requested proactive alerts 128 for the user device 102 and/or for special contacts (e.g., the special contact device 120, etc.). It should be understood that this example embodiment is illustrative, and therefore should not be construed as being limiting in any way.

If the server computer 116 determines, in operation 404A, that the proactive alerts 128 are to be provided to the special contacts associated with the user device 102, the method 400A can proceed to operation 406A. At operation 406A, the server computer 116 can generate proactive alerts 128 for the special contacts associated with the user device 102. The proactive alerts 128 can inform one or more special contact (e.g., by being output in a user interface at the special contact device 120) that the user device 102 has limited connectivity. This proactive alert 128 can be provided to attempt to reduce attempts to contact the user device 102 (e.g., to avoid using bandwidth available to the user device 102, to avoid missed calls or undelivered content, for other reasons, or the like). Thus, in operation 404A, the server computer 116 can send the alerts 128 proactively and/or can trigger delivery of the alerts 128 proactively via other entities and/or resources. It should be understood that this example embodiment is illustrative, and therefore should not be construed as being limiting in any way.

From operation 406A, the method 400A can proceed to operation 408A. The method 400A also can proceed to operation 408A from operation 404A if the server computer 116 determines, in operation 404A, that the proactive alerts 128 are not to be provided to the special contacts associated with the user device 102. At operation 408A, the server computer 116 can determine if a special contact has contacted (or tried to contact) the user device 102 (e.g., called the user device 102, sent data to the user device 102, or the like). It can be appreciated that the special contact (e.g., via the special contact device 120) may attempt to communicate with the user device 102 with or without having received proactive alerts 128. Thus, the special contact device 120 may attempt to call the user device 102, to establish a video session or video call with the user device 102, to send files or data to the user device 102, or the like.

In any event, such communications may not be possible and/or may not meet a desired quality-of-service (e.g., by the user, by network operators, or the like) due to the current limited connectivity of the user device 102. As such, the attempted communications with the user device 102 may be denied by various network entities (at the direction of the coverage management service 114 in some embodiments) and/or such communications may not be completed, connected, and/or delivered due to the limited connectivity of the user device 102. In any event, the server computer 116 can detect the attempted communication in operation 408A.

If the server computer 116 determines, in operation 408A, that a special contact has contacted (or tried to contact) the user device 102, the method 400A can proceed to operation 410A. At operation 410A, the server computer 116 can determine if a follow-up call (or other communication) is requested by the user device 102 for calls or other communications missed from special contacts due to limited connectivity of a direct-to-cell satellite connection of the user device 102. According to various embodiments of the concepts and technologies disclosed herein, the user or other entity associated with the user device 102 can set preferences or settings that enable follow-up calls or communications for special contacts if an attempted communication fails while the user device 102 is connected to a limited connectivity connection associated with a direct-to-cell satellite network 110.

As used herein, a follow-up call or communication can correspond to a telephone call, data session, data delivery or other communication that can be established once the user device 102 is no longer connected only to the limited connectivity connection associated with a direct-to-cell satellite network 110 (e.g., once the user device 102 is using the limited connectivity connection associated with a direct-to-cell satellite network 110 only for a backup connection and/or is no longer connected to the limited connectivity connection associated with a direct-to-cell satellite network 110 and is instead connected to another network connection such as a WiFi connection, high-speed cellular connection, or the like). As such, in operation 410A, the server computer 116 can determine if preferences or settings associated with the user device 102 request such follow-up communications. It should be understood that this example embodiment is illustrative, and therefore should not be construed as being limiting in any way.

If the server computer 116 determines, in operation 410A, that a follow-up call (or other communication) is not requested by the user device 102 for calls or other communications missed from special contacts due to limited connectivity of a direct-to-cell satellite connection of the user device 102, the method 400A can proceed to operation 412A. At operation 412A, the server computer 116 can send alerts 128 to the user device 102 and the special contact (e.g., the special contact device 120). The alerts 128 sent in operation 412A can inform the user device 102 and/or the special contact device 120 that the user device 102 is currently connected to a limited connectivity connection associated with a direct-to-cell satellite network 110. Of course, the alerts 128 sent in operation 412A to the user device 102 (or intended for the user device 102) may not be delivered until the user device 102 is no longer connected to the limited connectivity connection associated with a direct-to-cell satellite network 110, in some embodiments. In some other embodiments, the alert 128 sent to the user device 102 in operation 412A can be sent using low-bandwidth means (e.g., text messages) and therefore may be delivered even in limited connectivity situations in some embodiments.

In some other embodiments, the alerts 128 sent to the special contact device 120 in operation 412A can include language suggesting that the special contact device 120 try to contact or communicate with the user device 102 via an alternative communication format (e.g., text message, or the like) so that the communication can be delivered while the user device 102 is connected to the limited connectivity connection associated with a direct-to-cell satellite network 110. In some other embodiments, the alert 128 can include an option (e.g., a yes or no choice) to send a notification or alert 128 to the user device 102 via the other mode of communication. It should be understood that this example embodiment is illustrative, and therefore should not be construed as being limiting in any way.

If the server computer 116 determines, in operation 410A, that a follow-up call (or other communication) is requested by the user device 102 for calls or other communications missed from special contacts due to limited connectivity of a direct-to-cell satellite connection of the user device 102, the method 400A can proceed to operation 414A. At operation 414A, the server computer 116 can track a status of the network connection of the user device 102. According to various embodiments of the concepts and technologies disclosed herein, the server computer 116 can perform operation 414A by waiting for a subsequent release of device data 118 (or a subsequent datapoint in a stream that corresponds to the device data 118, for example). In some other embodiments, the server computer 116 may query other devices (e.g., network monitors or the like), wait for communications from the user device 102, or otherwise track a status of the network connection of the user device 102. Regardless of how the status of the network connection of the user device 102 is tracked, the server computer 116 can track the status in operation 414A. It should be understood that this example embodiment is illustrative, and therefore should not be construed as being limiting in any way.

From operation 414A, the method 400A can proceed to operation 416A. At operation 416A, the server computer 116 can determine if network connection of the user device 102 has changed. According to various embodiments of the concepts and technologies disclosed herein, operation 416A can correspond to the server computer 116 determining if the user device 102 has connected to a network connection other than a connection to a direct-to-cell satellite network 110. Thus, operation 416A can correspond to the server computer 116 determining that the user device 102 has disconnected from a network connection with limited connectivity (e.g., limited in terms of latency, bandwidth, and the like as is the case for direct-to-cell satellite connections) to a network connection having improved performance relative to the direct-to-cell connection such as a cellular connection, a WiFi connection, or the like.

In some other embodiments, operation 416A can correspond to the server computer 116 determining that the user device 102 has remained connected to a network connection with limited connectivity (e.g., a direct-to-cell satellite connection), but now has a primary or backup network connection that has improved performance relative to the direct-to-cell connection such as a cellular connection, a WiFi connection, or the like. Because other changes to the network connection of the user device 102 are possible in operation 416A, it should be understood that operation 416A can generally correspond to the server computer 116 determining that communications with the user device 102 is no longer limited to a limited connectivity direct-to-cell network connection. It should be understood that this example embodiment is illustrative, and therefore should not be construed as being limiting in any way.

If the server computer 116 determines in operation 416A that the network connection of the user device 102 has not changed, the method 400A can return to operation 414A where the server computer 116 can continue to track the status of the network connection of the user device 102. It can be appreciated that operations 414A-416A of the method 400A can be iterated until the user device 102 determines, in any iteration of operations 416A, that the network connection of the user device 102 has changed. It should be understood that this example embodiment is illustrative, and therefore should not be construed as being limiting in any way.

If the server computer 116 determines, in any iteration of operation 416A, that the network connection of the user device 102 has changed (e.g., from only a limited connectivity direct-to-cell satellite connection to some other network connection and/or combination of network connections), the method 400A can proceed to operation 418A. At operation 418A, the server computer 116 can connect the special contact (that was determined to have contacted or tried to contact the user device 102 in operation 408A) to the user device 102 and/or trigger other network entities, resources, the user device 102, and/or the special contact device 120 to reattempt the connection or communication. In some embodiments, the server computer 116 can trigger other devices to connect the special contact device 120 to the user device 102. In any event, operation 418A can correspond to the server computer 116 reconnecting the special contact device 120 with the user device 102 either directly or via other devices, entities, and/or resources. It should be understood that this example embodiment is illustrative, and therefore should not be construed as being limiting in any way.

From operation 418A, the method 400A can proceed to operation 420A. The method 400A also can proceed to operation 420A from operation 412A. The method 400A can end at operation 420A.

Turning now to FIG. 4B, aspects of a method 400B for enabling communications with special contacts during direct-to-cell satellite coverage will be described in detail, according to an illustrative embodiment. For purposes of illustrating and describing the concepts of the present disclosure, the method 400B is described herein as being performed by the server computer 116 via execution of one or more software modules such as, for example, the coverage management service 114. It should be understood that additional and/or alternative devices and/or network nodes can provide the functionality described herein via execution of one or more modules, applications, and/or other software including, but not limited to, the coverage management service 114. Thus, the illustrated embodiments are illustrative, and should not be viewed as being limiting in any way.

It can be appreciated with reference to FIG. 3 that the functionality of the method 400B illustrated in FIG. 4B can be performed, in some embodiments, by the server computer 116 in operation 314 of the method 300 illustrated in FIG. 3. It should be understood, however, that the functionality of the method 400B illustrated and described herein can be performed by the server computer 116 at additional and/or alternative times. Thus, it should be understood that the illustrated example embodiment is illustrative, and therefore should not be construed as being limiting in any way.

The method 400B begins at operation 402B. At operation 402B, the server computer 116 can determine notification preferences for the user device 102. It can be appreciated that in operation 402B, the record 126 may already have been retrieved by the server computer 116 (e.g., in operation 304 of the method 300 illustrated in FIG. 3). It should be understood, however, that operation 402B can include the server computer 116 retrieving the record 126 for the user device 102 in some embodiments. In any event, the server computer 116 can analyze the record 126 and determine how notifications (e.g., alerts 128 and the like) are to be generated for the special contacts associated with the user device 102. The notification preferences also can indicate if a tracking history associated with the user device 102 (which can be generated in some instances when the user device 102 is connected to the limited connectivity connection associated with the direct-to-cell satellite network 110) is to be shared with special contacts and/or one or more special contact device 120. Because notification preferences can be determined by the server computer 116 in additional and/or alternative manners (e.g., receiving the notification preferences from other devices, settings, or the like), it should be understood that this example embodiment is illustrative, and therefore should not be construed as being limiting in any way.

From operation 402B, the method 400B can proceed to operation 404B. At operation 404B, the server computer 116 can determine if a tracking history feature is enabled. In particular, according to various embodiments of the concepts and technologies disclosed herein, a tracking history (e.g., a digital breadcrumb trail) for the user device 102 can be generated when the user device 102 is connected to a limited connectivity direct-to-cell satellite network 110. In some embodiments, the tracking history for the user device 102 can be provided by the user device 102 with the server computer 116 (e.g., the coverage management service 114). In some embodiments, the tracking history for the user device 102 can be shared with special contacts (e.g., with one or more special contact device 120), as will be explained in more detail below. Thus, operation 404B can correspond to the server computer 116 determining if the user device 102 has enabled capturing of the tracking history in some embodiments, and if a user device 102 has enabled sharing of the tracking history with special contacts and/or special contact devices 120. In some embodiments, including the embodiment illustrated in FIG. 4B, the server computer 116 may determine if sharing of the captured tracking history is enabled separately. It should be understood that this example embodiment is illustrative, and therefore should not be construed as being limiting in any way.

If the server computer 116 determines, in operation 404B, that the tracking history feature is enabled, the method 400B can proceed to operation 406B. At operation 406B, the server computer 116 can instruct the user device 102 to provide history data (e.g., as part of releases of device data 118 and/or independently as data points) to the server computer 116. In some embodiments, operation 406B can correspond to the server computer 116 delivering (or triggering delivery of) an alert 128 and/or command to the user device 102, with the alert 128 or command instructing the user device 102 to capture the history data. Because the instruction to the user device 102 to capture history data can be provided in additional and/or alternative manners, and because the capturing of history data may be automatic in various embodiments, it should be understood that these example embodiments are illustrative, and therefore should not be construed as being limiting in any way.

From operation 406B, the method 400B can proceed to operation 408B. At operation 408B, the server computer 116 can obtain history data. In various embodiments of the concepts and technologies disclosed herein, the history data can be obtained from the user device 102 (e.g., as part of the device data 118, independently, or the like). In some other embodiments, the server computer 116 can obtain the history data from network monitors, network controllers, location servers, and/or other network devices and/or entities. The history data obtained in operation 408B can include, for example, a data record that identifies a user, device, or other identifier (e.g., identity of the user device 102, identity of a user of the user device 102, identity of some other entity, combinations thereof, or the like); a geographic location of the user device 102 when the history data was generated; a time at which the user device 102 was at the geographic location; a network connection that is active at the user device 102 at the time; and the like. In some embodiments, the history data can include more or fewer datapoints. It should be understood that this example embodiment is illustrative, and therefore should not be construed as being limiting in any way.

From operation 408B, the method 400B can proceed to operation 410B. At operation 410B, the server computer 116 can update a record 126 associated with the user device 102 using the history data. Thus, it can be appreciated that operation 410B can correspond to the server computer 116 updating a location indicated in a record 126 that is associated with the user device 102 based on the history data obtained in operation 408B, updating a network connection indicated in a record 126 that is associated with the user device 102 based on the history data obtained in operation 408B, and the like. As such, it can be appreciated that the history data can be used to provide for more than one purpose according to various embodiments of the concepts and technologies disclosed herein.

From operation 410B, the method 400B can proceed to operation 412B. At operation 412B, the server computer 116 can determine if the tracking history for the user device 102 is to be shared with special contacts. In particular, according to various embodiments of the concepts and technologies disclosed herein, preferences and/or settings associated with the user device 102 can specify if a tracking history that is generated when the user device 102 is connected to a limited connectivity direct-to-cell satellite network 110 is to be shared with others such as special contacts. Additionally, or alternatively, operation 412B can correspond to the server computer 116 querying the user device 102 (e.g., creating an option window that is displayed at the user device 102) to determine if tracking history is to be shared with others such as special contacts. Because the server computer 116 can determine that the tracking history is to be shared with others in additional and/or alternative manners, it should be understood that these example embodiments are illustrative, and therefore should not be construed as being limiting in any way.

If the server computer 116 determines, in operation 412B, that the tracking history of the user device 102 is to be shared with special contacts, the method 400B can proceed to operation 414B. At operation 414B, the server computer 116 can notify the special contact device 120 that the tracking history of the user device 102 is available and/or enable access to the tracking history for the special contact. In some embodiments, the server computer 116 can perform operation 414B by sending (or triggering delivery of) an alert 128 to the special contact device 120. The alert 128 sent in operation 414B can include a link or other functionality for viewing the tracking history (e.g., in a map format with datapoints showing geographic location of the user device 102 over time; in a list of datapoints that indicate geographic location, time, network connectivity, or the like). Because the tracking history can be provided in additional and/or alternative formats, it should be understood that these example embodiments are illustrative, and therefore should not be construed as being limiting in any way.

From operation 414B, the method 400B can proceed to operation 416B. The method 400B also can proceed to operation 416B from operation 412B if the server computer 116 determines, in operation 412B, that the tracking history that is generated when the user device 102 is connected to a limited connectivity direct-to-cell satellite network 110 is not to be shared with others such as special contacts.

At operation 416B, the server computer 116 can track a status of the network connection of the user device 102. According to various embodiments of the concepts and technologies disclosed herein, the server computer 116 can perform operation 416B by waiting for a subsequent release of device data 118 (or a subsequent datapoint in a stream that corresponds to the device data 118, for example). In some other embodiments, the server computer 116 may query other devices (e.g., network monitors or the like), wait for communications from the user device 102, or otherwise track a status of the network connection of the user device 102. Regardless of how the status of the network connection of the user device 102 is tracked, the server computer 116 can track the status in operation 416B. It should be understood that this example embodiment is illustrative, and therefore should not be construed as being limiting in any way.

From operation 416B, the method 400B can proceed to operation 418B. At operation 418B, the server computer 116 can determine if network connection of the user device 102 has changed. According to various embodiments of the concepts and technologies disclosed herein, operation 418B can correspond to the server computer 116 determining if the user device 102 has connected to a network connection other than a connection to a direct-to-cell satellite network 110. Thus, operation 418B can correspond to the server computer 116 determining that the user device 102 has disconnected from a network connection with limited connectivity (e.g., limited in terms of latency, bandwidth, and the like as is the case for direct-to-cell satellite connections) to a network connection having improved performance relative to the direct-to-cell connection such as a cellular connection, a WiFi connection, or the like.

In some other embodiments, operation 418B can correspond to the server computer 116 determining that the user device 102 has remained connected to a network connection with limited connectivity (e.g., a direct-to-cell satellite connection), but now has a primary or backup network connection that has improved performance relative to the direct-to-cell connection such as a cellular connection, a WiFi connection, or the like. Because other changes to the network connection of the user device 102 are possible in operation 418B, it should be understood that operation 418B can generally correspond to the server computer 116 determining that communications with the user device 102 is no longer limited to a limited connectivity direct-to-cell network connection. It should be understood that this example embodiment is illustrative, and therefore should not be construed as being limiting in any way.

If the server computer 116 determines, in operation 418B, that the network connection of the user device 102 has not changed (e.g., from only a limited connectivity direct-to-cell satellite connection to some other network connection and/or combination of network connections), the method 400B can return to operation 408B and the server computer 116 can again obtain history data. Thus, it can be appreciated that operations 408B-418B can be iterated until the server computer 116 determines, in any iteration of operation 418B, that the network connection of the user device 102 has changed.

If the server computer 116 determines, in any iteration of operation 418B, that the network connection of the user device 102 has changed (e.g., from only a limited connectivity direct-to-cell satellite connection to some other network connection and/or combination of network connections), the method 400B can return to operation 420B. The method 400B can also proceed to operation 420B from operation 404B if the server computer 116 determines, in operation 404B, that the tracking history is not enabled for the user device 102. The method 400B can end at operation 420B.

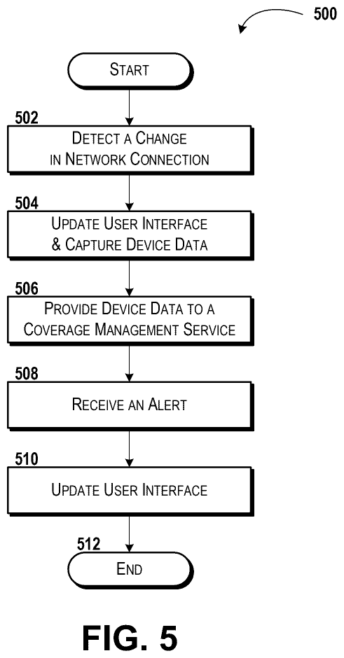

Turning now to FIG. 5, aspects of a method 500 for enabling communications with special contacts during direct-to-cell satellite coverage will be described in detail, according to an illustrative embodiment. For purposes of illustrating and describing the concepts of the present disclosure, the method 500 is described herein as being performed by the user device 102 via execution of one or more software modules such as, for example, the coverage management application 108. It should be understood that additional and/or alternative devices and/or network nodes can provide the functionality described herein via execution of one or more modules, applications, and/or other software including, but not limited to, the coverage management application 108. Thus, the illustrated embodiments are illustrative, and should not be viewed as being limiting in any way.

The method 500 begins at operation 502. At operation 502, the user device 102 can detect a change in a network connection of the user device 102. In operation 502, the user device 102 can detect if the user device 102 has connected to a network connection other than a previous network connection. In some embodiments, operation 502 can include the user device 102 connecting to network connection associated with a direct-to-cell satellite network 110 as a primary network, backup network, or the like; the user device 102 connecting to a network connection associated with the wireless network 112 as a primary network, backup network, or the like; the user device 102 disconnecting from a network connection; combinations thereof; or the like. Thus, operation 502 can include the user device 102 detecting connection to or disconnection from a network connection with limited connectivity (e.g., limited in terms of latency, bandwidth, and the like as is the case for direct-to-cell satellite connections) with or without a backup network connection that has improved performance relative to the network connection with the direct-to-cell satellite network 110, for example, a cellular connection, a WiFi connection, or the like.

As such, it can be appreciated that operation 502 can correspond to the user device 102 detecting that the user device 102 has remained connected to a network connection with limited connectivity (e.g., a direct-to-cell satellite connection), but now has a primary or backup network connection that has improved performance relative to the direct-to-cell connection such as a cellular connection, a WiFi connection, or the like. Because other changes to the network connection of the user device 102 can be detected by the user device 102 in operation 502, it should be understood that the above example embodiments are illustrative, and therefore should not be construed as being limiting in any way.

From operation 502, the method 500 can proceed to operation 504. At operation 504, the user device 102 can update a user interface and capture device data 118. In particular, operation 504 can correspond to the user device 102 updating a user interface at the user device 102 (e.g., to show the new or changed network connection detected in operation 502) and capturing the components of the device data 118 illustrated and described herein, namely, identity data (identifying the user device 102 and/or a user thereof), connection data (identifying the current network connection of the user device 102), and/or other data included in the device data 118 in some embodiments. Thus, operation 504 can include the user device 102 generating a release of the device data 118 (e.g., due to the detected change in the network connection). It should be understood that this example embodiment is illustrative, and therefore should not be construed as being limiting in any way.

From operation 504, the method 500 can proceed to operation 506. At operation 506, the user device 102 can provide the device data 118 captured and/or created in operation 504 to the coverage management service 114. In various embodiments, operation 506 can correspond to the user device 102 transmitting the device data 118 to the server computer 116. Because the user device 102 can provide the device data 118 to the coverage management service 114 in additional and/or alternative manners, it should be understood that this example embodiment is illustrative, and therefore should not be construed as being limiting in any way.

From operation 506, the method 500 can proceed to operation 508. At operation 508, the user device 102 can receive an alert 128. The alert 128 obtained in operation 508 can be generated by the coverage management service 114 in some embodiments. The alert 128 obtained in operation 508 can indicate that the user device 102 is connected to a limited connectivity network connection, that a special contact device 120 associated with a special contact has tried to contact the user device 102, that a communication that was attempted when the user device 102 had limited connectivity is being retried or reestablished, other notifications illustrated and described herein, combinations thereof, or the like. The alert 128 also can provide options at the user device 102 such as, for example, options to enable proactive alerts 128 to special contacts, to allow or establish follow-up calls or other communications, options to enable history tracking (e.g., a digital breadcrumb trail), options to share tracked history (e.g., a digital breadcrumb trail) with special contacts, options to access settings for special contacts, combinations thereof, or the like. Because additional options and/or alerts 128 are possible and are contemplated, it should be understood that these example embodiments are illustrative, and therefore should not be construed as being limiting in any way.

From operation 508, the method 500 can proceed to operation 510. At operation 510, the user device 102 can update a user interface at the user device 102. It can be appreciated that the user interface can be updated with information about network connections, alerts 128, options to enable or disable special contact functionality, combinations thereof, or the like. Some example user interfaces are illustrated and described hereinbelow with reference to FIGS. 6A-6G. It should be understood that these example embodiments are illustrative, and therefore should not be construed as being limiting in any way.

From operation 510, the method 500 can proceed to operation 512. The method 500 can end at operation 512.

FIGS. 6A-6G are user interface (“UI”) diagrams showing aspects of UIs for using and/or interacting with coverage management service 114 and/or the coverage management application 108, according to some illustrative embodiments. FIG. 6A shows an illustrative screen display 600A. According to some embodiments of the concepts and technologies described herein, the screen display 600A can be generated by a device such as the user device 102 via interactions with the coverage management service 114 and/or the coverage management application 108. It should be appreciated that the UI diagram illustrated in FIG. 6A is illustrative of one contemplated example of the UIs that can be generated and/or displayed in accordance with the concepts and technologies disclosed herein, and therefore should not be construed as being limiting in any way.

According to various embodiments, the screen display 600A can be presented, for example, when the user device 102 has determined that the user device 102 has connected a limited connectivity network connection associated with a direct-to-cell satellite network 110. It can be appreciated with reference to the embodiments of the concepts and technologies disclosed herein that the user device 102 may determine that the user device 102 has connected to the limited connectivity connection based on detecting the active network connections locally, or based on an alert 128, which may be received from a server computer 116 that executes coverage management service 114 and/or other devices, entities, or resources.

In the example screen display 600A shown in FIG. 6A, the user device 102 is illustrated as displaying a home screen 602. It should be understood that this example embodiment is illustrative, and therefore should not be construed as being limiting in any way. Because one or more elements of the screen display 600A illustrated in FIG. 6A can be displayed at additional and/or alternative times (e.g., when the user device 102 is locked), and because one or more elements of the screen display 600A may or may not be included in all embodiments, it should be understood that the illustrated example embodiment is illustrative and therefore should not be construed as being limiting in any way.

As is generally understood, the home screen 602 can be configured to present some information and/or options to a user while the user device 102 is unlocked and/or at other times. For example, as is known and as is illustrated in FIG. 6A, the home screen 602 can include various types of data and/or information such as time and/or date information 604, which can display a time and/or date; carrier information (not illustrated in FIG. 6A), which can be included to indicate a carrier associated with a primary network connection and/or network to which the user device 102 is connected at the time; signal strength information 606 for the primary network connection, which can indicate a strength of a signal associated with the primary network to which the user device 102 is connected at the time; a WiFi signal indicator (not shown), which can indicate in some instances that a WiFi connection is available, active, and optionally an associated signal strength of the WiFi signal; battery charge information 608; a direct-to-cell satellite connection indicator 610, which optionally can include an associated signal strength indicator (not shown); and one or more application icons (the application icons are not labeled in FIG. 6A to avoid obscuring additional details of the home screen 602).

As shown in FIG. 6A, a status of one or more networks can be displayed on the home screen 602 and/or elsewhere. In the illustrated embodiment, a status of “offline” is displayed under the signal strength information 606, thereby indicating that the primary network connection such as a cellular network connection to a terrestrial cellular network is not active at the current time; and a status of “active” is displayed under the direct-to-cell satellite connection indicator 610, thereby indicating that a direct-to-cell satellite connection is active and/or connected at the current time and is functioning as the only network connection for the user device 102. It should be understood that this example embodiment is illustrative, and therefore should not be construed as being limiting in any way.

According to various embodiments of the concepts and technologies disclosed herein, the screen display 600A can include a special contact update window 612. The special contact update window 612 can be provided in various conditions illustrated and described herein to provide information about special contacts, to obtain input from a user, to enable and/or disable options for special contacts, to access settings for special contacts, combinations thereof, or the like. In the embodiment shown in FIG. 6A, the special contact update window 612 is illustrated as indicating that the user device 102 has connected to a limited connectivity direct-to-cell satellite connection, and asks the user if special contacts should be proactively alerted. It should be understood that this example embodiment is illustrative, and therefore should not be construed as being limiting in any way.

The special contact update window 612 can include a UI control 614 for entering a “yes” option and a UI control 616 for entering a “no” option. In the embodiment shown in FIG. 6A, selection of the UI control 614 can cause the user device 102 to indicate to the coverage management service 114 that proactive alerts 128 should be sent to the special contacts defined for the user device 102, and selection of the UI control 616 can cause the user device 102 to indicate to the coverage management service 114 that proactive alerts 128 should not be sent to the special contacts defined for the user device 102. It can be appreciated that the option to send proactive alerts 128 can be defined in settings and/or preferences reflected in a record 126 for the user device 102 in some embodiments, and therefore selection of the UI control 614 or the UI control 616 may not be required in all embodiments. As such, it should be understood that this example embodiment is illustrative, and therefore should not be construed as being limiting in any way.

The special contact update window 612 can also include a UI control 618 for accessing one or more settings or preferences relating to special contacts. Selection of the UI control 618 can cause the user device 102 to present a settings screen, or the like, to configure and/or change preferences or settings associated with the special contacts functionality illustrated and described herein; to create, modify, and/or delete special contacts; to enable and/or disable history tracking of the user device 102; to access other options as illustrated and described herein; combinations thereof; or the like. Because the illustrated embodiment of the screen display 600A is illustrative, and because the screen display 600A can include additional and/or alternative information, it should be understood that the embodiment of FIG. 6A is illustrative, and therefore should not be construed as being limiting in any way.

FIG. 6B shows an illustrative screen display 600B. According to some embodiments of the concepts and technologies described herein, the screen display 600B can be generated by a device such as the special contact device 120 via interactions with the coverage management service 114 and/or the coverage management application 108 (executed at the special contact device 120). It should be appreciated that the UI diagram illustrated in FIG. 6B is illustrative of one contemplated example of the UIs that can be generated and/or displayed in accordance with the concepts and technologies disclosed herein, and therefore should not be construed as being limiting in any way.

According to various embodiments, the screen display 600B can be presented, for example, when the special contact device has received an alert 128 that indicates that the user device 102 has connected a limited connectivity network connection associated with a direct-to-cell satellite network 110. In the example screen display 600B shown in FIG. 6B, the special contact device 120 is illustrated as displaying a home screen 602. While the home screen of the special contact device 120 is substantially similar to the home screen 602 of the user device 102, it should be understood that this example embodiment is illustrative, and therefore should not be construed as being limiting in any way. Because one or more elements of the screen display 600B illustrated in FIG. 6B can be displayed at additional and/or alternative times (e.g., when the special contact device 120 is locked), and because one or more elements of the screen display 600B may or may not be included in all embodiments, it should be understood that the illustrated example embodiment is illustrative and therefore should not be construed as being limiting in any way.

As is illustrated in FIG. 6B, the home screen 602 can include time and/or date information 604; carrier information (not illustrated in FIG. 6B); signal strength information 606 for the primary network connection, which can indicate a strength of a signal associated with the primary network to which the special contact device 120 is connected at the time; a WiFi signal indicator (not shown); battery charge information 608; a direct-to-cell satellite connection indicator 610; the application icons; other information, combinations thereof; or the like. As shown in FIG. 6B, a status of “active” is displayed under the signal strength information 606, thereby indicating that a primary network connection for the special contact device 120, for example a cellular network connection to a terrestrial cellular network, is active at the current time and a status of “backup” is displayed under the direct-to-cell satellite connection indicator 610, thereby indicating that a direct-to-cell satellite connection is active and/or connected at the current time, but is functioning as only a backup network connection for the special contact device 120. It should be understood that this example embodiment is illustrative, and therefore should not be construed as being limiting in any way.

According to various embodiments of the concepts and technologies disclosed herein, the screen display 600B includes another embodiment of the special contact update window 612. In the embodiment shown in FIG. 6B, the special contact update window 612 is illustrated as indicating that the user device 102 (associated with a user named Jake Josephs, a contact of a special contact associated with the special contact device 120) has connected to a limited connectivity direct-to-cell satellite connection, has designated the special contact device as a special contact, and asked if the special contact device 120 should be updated if the user device 102 later connects to a network connection in addition to or instead of the limited connectivity direct-to-cell satellite connection. It should be understood that this example embodiment is illustrative, and therefore should not be construed as being limiting in any way.

The special contact update window 612 can include a UI control 614 for entering a “yes” option and a UI control 616 for entering a “no” option. In the embodiment shown in FIG. 6B, selection of the UI control 614 can cause the special contact device 120 to indicate to the coverage management service 114 that an alert 128 should be sent to the special contact device 120 when the user device 102 connects to another network connection other than and/or in addition to the limited connectivity direct-to-cell satellite connection to which the user device 102 is currently connected. Selection of the UI control 616 can cause the special contact device 120 to indicate to the coverage management service 114 that an alert 128 should not be sent to the special contact device 120 when the user device 102 connects to another network connection other than and/or in addition to the limited connectivity direct-to-cell satellite connection to which the user device 102 is currently connected. Because the illustrated embodiment of the screen display 600B is illustrative, and because the screen display 600B can include additional and/or alternative information, it should be understood that the embodiment of FIG. 6B is illustrative, and therefore should not be construed as being limiting in any way.

FIG. 6C shows an illustrative screen display 600C. According to some embodiments of the concepts and technologies described herein, the screen display 600C can be generated by a device such as the user device 102 via interactions with the coverage management service 114 and/or the coverage management application 108. It should be appreciated that the UI diagram illustrated in FIG. 6C is illustrative of one contemplated example of the UIs that can be generated and/or displayed in accordance with the concepts and technologies disclosed herein, and therefore should not be construed as being limiting in any way.

According to various embodiments, the screen display 600C can be presented, for example, while the user device 102 is connected to a limited connectivity network connection associated with a direct-to-cell satellite network 110, and a special contact has indicated, e.g., at the special contact device 120, that an automatic redial (or other attempt to reconnect to the user device 102) should completed when the user device 102 has connected to a network connection other than (or in addition to) the limited connectivity connection associated with the direct-to-cell satellite network 110. It should be understood that this example embodiment is illustrative, and therefore should not be construed as being limiting in any way.

In the example screen display 600C shown in FIG. 6C, the user device 102 is illustrated as displaying a home screen 602. In FIG. 6C, the home screen 602 can include time and/or date information 604; carrier information (not illustrated in FIG. 6C); signal strength information 606; battery charge information 608; direct-to-cell satellite connection indicator 610; and one or more application icons. In the illustrated embodiment, a status of “offline” is displayed under the signal strength information 606 and a status of “active” is displayed under the direct-to-cell satellite connection indicator 610. It should be understood that this example embodiment is illustrative, and therefore should not be construed as being limiting in any way.

In the embodiment shown in FIG. 6C, the special contact update window 612 is illustrated as indicating that a special contact of the user device 102 has requested an automatic redial (to the user device 102) when the user device 102 is no longer connected to a limited connectivity direct-to-cell satellite connection and/or has connected to another network connection that does not have the limitations of the direct-to-cell satellite connection. Thus, the special contact window 612 can be used to enable a user of the user device 102 to allow or block the automatic redial (or communication resend or reestablishment) requested by the special contact (e.g., via the special contact device 120). It should be understood that this example embodiment is illustrative, and therefore should not be construed as being limiting in any way.

The special contact update window 612 can include a UI control 614 for entering a “yes” option and a UI control 616 for entering a “no” option. In the embodiment shown in FIG. 6C, selection of the UI control 614 can cause the user device 102 to indicate to the coverage management service 114 that the automatic redial (or other retried communication) requested by the special contact should be allowed, and selection of the UI control 616 can cause the user device 102 to indicate to the coverage management service 114 that the automatic redial (or other retried communication) requested by the special contact should not be allowed. It can be appreciated that options to allow or block automatic redials or other reattempts for communications can be defined in settings and/or preferences reflected in a record 126 for the user device 102 in some embodiments, and therefore selection of the UI control 614 or the UI control 616 may not be required in all embodiments. As such, it should be understood that this example embodiment is illustrative, and therefore should not be construed as being limiting in any way. The special contact update window 612 can also include a UI control 618 for accessing one or more settings or preferences relating to special contacts. Because the illustrated embodiment of the screen display 600C is illustrative, and because the screen display 600C can include additional and/or alternative information, it should be understood that the embodiment of FIG. 6C is illustrative, and therefore should not be construed as being limiting in any way.

FIG. 6D shows an illustrative screen display 600D. According to some embodiments of the concepts and technologies described herein, the screen display 600D can be generated by a device such as the special contact device 120 via interactions with the coverage management service 114 and/or the coverage management application 108 (executed at the special contact device 120). It should be appreciated that the UI diagram illustrated in FIG. 6D is illustrative of one contemplated example of the UIs that can be generated and/or displayed in accordance with the concepts and technologies disclosed herein, and therefore should not be construed as being limiting in any way.

According to various embodiments, the screen display 600D can be presented, for example, when the special contact device has received an alert 128 that indicates that the user device 102 has connected a limited connectivity network connection associated with a direct-to-cell satellite network 110. In the example screen display 600D shown in FIG. 6D, the special contact device 120 is illustrated as displaying a home screen 602. While the home screen of the special contact device 120 is substantially similar to the home screen 602 of the user device 102, it should be understood that this example embodiment is illustrative, and therefore should not be construed as being limiting in any way. Because one or more elements of the screen display 600D illustrated in FIG. 6D can be displayed at additional and/or alternative times (e.g., when the special contact device 120 is locked), and because one or more elements of the screen display 600D may or may not be included in all embodiments, it should be understood that the illustrated example embodiment is illustrative and therefore should not be construed as being limiting in any way.

As is illustrated in FIG. 6D, the home screen 602 can include time and/or date information 604; carrier information (not illustrated in FIG. 6D); signal strength information 606 for the primary network connection, which can indicate a strength of a signal associated with the primary network to which the special contact device 120 is connected at the time; a WiFi signal indicator (not shown); battery charge information 608; a direct-to-cell satellite connection indicator 610; the application icons; other information, combinations thereof; or the like. As shown in FIG. 6D, a status of “active” is displayed under the signal strength information 606, thereby indicating that a primary network connection for the special contact device 120, for example a cellular network connection to a terrestrial cellular network, is active at the current time and a status of “backup” is displayed under the direct-to-cell satellite connection indicator 610, thereby indicating that a direct-to-cell satellite connection is active and/or connected at the current time, but is functioning as only a backup network connection for the special contact device 120. It should be understood that this example embodiment is illustrative, and therefore should not be construed as being limiting in any way.

According to various embodiments of the concepts and technologies disclosed herein, the screen display 600D includes another embodiment of the special contact update window 612. In the embodiment shown in FIG. 6D, the special contact update window 612 is illustrated as indicating that the user device 102 (associated with a user named Jake Josephs, a contact of a special contact associated with the special contact device 120) has connected to a limited connectivity direct-to-cell satellite connection, has designated the special contact device as a special contact, and asked if the special contact device 120 requests that a communication (that was attempted while the user device 102 had limited connectivity) should be retried and/or reestablished if the user device 102 later connects to a network connection in addition to or instead of the limited connectivity direct-to-cell satellite connection. It can be appreciated that the special contact update window 612 shown in FIG. 6D can be presented, for example, in response to the special contact device 120 attempting to call or otherwise communicate with the user device 102 while the user device 102 has limited connectivity. It should be understood that this example embodiment is illustrative, and therefore should not be construed as being limiting in any way.

The special contact update window 612 can include a UI control 614 for entering a “yes” option and a UI control 616 for entering a “no” option. In the embodiment shown in FIG. 6D, selection of the UI control 614 can cause the special contact device 120 to indicate to the coverage management service 114 that the special contact device 120 should be automatically reconnected to the user device 102 when the user device 102 connects to another network connection other than and/or in addition to the limited connectivity direct-to-cell satellite connection to which the user device 102 is currently connected. Selection of the UI control 616 can cause the special contact device 120 to indicate to the coverage management service 114 that the special contact device 120 should not be automatically reconnected to the user device 102 when the user device 102 connects to another network connection other than and/or in addition to the limited connectivity direct-to-cell satellite connection to which the user device 102 is currently connected. Because the illustrated embodiment of the screen display 600D is illustrative, and because the screen display 600D can include additional and/or alternative information, it should be understood that the embodiment of FIG. 6D is illustrative, and therefore should not be construed as being limiting in any way.

FIG. 6E shows an illustrative screen display 600E. According to some embodiments of the concepts and technologies described herein, the screen display 600E can be generated by a device such as the user device 102 via interactions with the coverage management service 114 and/or the coverage management application 108. It should be appreciated that the UI diagram illustrated in FIG. 6E is illustrative of one contemplated example of the UIs that can be generated and/or displayed in accordance with the concepts and technologies disclosed herein, and therefore should not be construed as being limiting in any way.

According to various embodiments, the screen display 600E can be presented, for example, while the user device 102 is connected to a limited connectivity network connection associated with a direct-to-cell satellite network 110. In particular, the coverage management service 114 can provide information used by the user device 102 to generate the screen display 600E to inform the user device 102 that the user device 102 has limited connectivity and that a tracking history feature is enabled for the user device 102, as well as questioning if the user device 102 wants to share the tracking history with special contacts. It should be understood that this example embodiment is illustrative, and therefore should not be construed as being limiting in any way. In the example screen display 600E shown in FIG. 6E, the user device 102 is illustrated as displaying a home screen 602. In FIG. 6E, the home screen 602 can include time and/or date information 604; carrier information (not illustrated in FIG. 6E); signal strength information 606; battery charge information 608; direct-to-cell satellite connection indicator 610; and one or more application icons. In the illustrated embodiment, a status of “offline” is displayed under the signal strength information 606 and a status of “active” is displayed under the direct-to-cell satellite connection indicator 610. It should be understood that this example embodiment is illustrative, and therefore should not be construed as being limiting in any way.

In the embodiment shown in FIG. 6E, the special contact update window 612 is illustrated as indicating that the user device 102 has limited connectivity and that history tracking is occurring, along with questioning the user associated with the user device 102 if the history tracking should be provided to and/or shared with one or more special contact. Thus, the special contact window 612 can be used to enable a user of the user device 102 to allow or block the sharing of tracked history of the user device 102 with the special contact. It should be understood that this example embodiment is illustrative, and therefore should not be construed as being limiting in any way.

The special contact update window 612 can include a UI control 614 for entering a “yes” option and a UI control 616 for entering a “no” option. In the embodiment shown in FIG. 6E, selection of the UI control 614 can cause the user device 102 to indicate to the coverage management service 114 that the tracked history of the user device 102 should be shared with the special contacts, and selection of the UI control 616 can cause the user device 102 to indicate to the coverage management service 114 that the tracked history of the user device 102 should not be shared with the special contacts. It can be appreciated that options to allow or block sharing of tracked history with special contacts can be defined in settings and/or preferences reflected in a record 126 for the user device 102 in some embodiments, and therefore selection of the UI control 614 or the UI control 616 may not be required in all embodiments. As such, it should be understood that this example embodiment is illustrative, and therefore should not be construed as being limiting in any way. The special contact update window 612 can also include a UI control 618 for accessing one or more settings or preferences relating to special contacts. Because the illustrated embodiment of the screen display 600E is illustrative, and because the screen display 600E can include additional and/or alternative information, it should be understood that the embodiment of FIG. 6E is illustrative, and therefore should not be construed as being limiting in any way.

FIG. 6F shows an illustrative screen display 600F. According to some embodiments of the concepts and technologies described herein, the screen display 600F can be generated by a device such as the special contact device 120 via interactions with the coverage management service 114 and/or the coverage management application 108 (executed at the special contact device 120). It should be appreciated that the UI diagram illustrated in FIG. 6F is illustrative of one contemplated example of the UIs that can be generated and/or displayed in accordance with the concepts and technologies disclosed herein, and therefore should not be construed as being limiting in any way.

According to various embodiments, the screen display 600F can be presented, for example, when the special contact device has received an alert 128 that indicates that the user device 102 has connected a limited connectivity network connection associated with a direct-to-cell satellite network 110. In the example screen display 600F shown in FIG. 6F, the special contact device 120 is illustrated as displaying a home screen 602. While the home screen of the special contact device 120 is substantially similar to the home screen 602 of the user device 102, it should be understood that this example embodiment is illustrative, and therefore should not be construed as being limiting in any way. Because one or more elements of the screen display 600F illustrated in FIG. 6F can be displayed at additional and/or alternative times (e.g., when the special contact device 120 is locked), and because one or more elements of the screen display 600F may or may not be included in all embodiments, it should be understood that the illustrated example embodiment is illustrative and therefore should not be construed as being limiting in any way.

As is illustrated in FIG. 6F, the home screen 602 can include time and/or date information 604; carrier information (not illustrated in FIG. 6F); signal strength information 606 for the primary network connection, which can indicate a strength of a signal associated with the primary network to which the special contact device 120 is connected at the time; a WiFi signal indicator (not shown); battery charge information 608; a direct-to-cell satellite connection indicator 610; the application icons; other information, combinations thereof; or the like. As shown in FIG. 6F, a status of “active” is displayed under the signal strength information 606, thereby indicating that a primary network connection for the special contact device 120, for example a cellular network connection to a terrestrial cellular network, is active at the current time and a status of “backup” is displayed under the direct-to-cell satellite connection indicator 610, thereby indicating that a direct-to-cell satellite connection is active and/or connected at the current time, but is functioning as only a backup network connection for the special contact device 120. It should be understood that this example embodiment is illustrative, and therefore should not be construed as being limiting in any way.

According to various embodiments of the concepts and technologies disclosed herein, the screen display 600F includes another embodiment of the special contact update window 612. In the embodiment shown in FIG. 6F, the special contact update window 612 is illustrated as indicating that the user device 102 (associated with a user named Jake Josephs, a contact of a special contact associated with the special contact device 120) has connected to a limited connectivity direct-to-cell satellite connection, has designated the special contact device as a special contact, and asked if the special contact device 120 requests that the special contact indicate if the special contact wants to view or access a tracking history of the user device 102 (e.g., locations, times, and the like). It should be understood that this example embodiment is illustrative, and therefore should not be construed as being limiting in any way.

The special contact update window 612 can include a UI control 614 for entering a “yes” option and a UI control 616 for entering a “no” option. In the embodiment shown in FIG. 6F, selection of the UI control 614 can cause the special contact device 120 to indicate to the coverage management service 114 that the special contact device 120 should access and/or view the tracked history of the user device 102 (e.g., on a map view, in a list view, and/or in other views). Selection of the UI control 616 can cause the special contact device 120 to indicate to the coverage management service 114 that that the special contact device 120 should not access and/or view the tracked history of the user device 102 (e.g., on a map view, in a list view, and/or in other views). Because the illustrated embodiment of the screen display 600F is illustrative, and because the screen display 600F can include additional and/or alternative information, it should be understood that the embodiment of FIG. 6F is illustrative, and therefore should not be construed as being limiting in any way.

FIG. 6G shows an illustrative screen display 600G. According to some embodiments of the concepts and technologies described herein, the screen display 600G can be generated by a device such as the special contact device 120 via interactions with the coverage management service 114 and/or the coverage management application 108 (executed at the special contact device 120). It should be appreciated that the UI diagram illustrated in FIG. 6G is illustrative of one contemplated example of the UIs that can be generated and/or displayed in accordance with the concepts and technologies disclosed herein, and therefore should not be construed as being limiting in any way.

According to various embodiments, the screen display 600G can be presented, for example, when the special contact device has received an alert 128 that indicates that the user device 102 has connected a limited connectivity network connection associated with a direct-to-cell satellite network 110. In some embodiments, the screen display 600G can be presented, for example, in response to an alert 128 received by the special contact device 120 in response to attempting to establish a video call with the user device 102 at a time at which the user device 102 had limited connectivity that was not sufficient to support a video call. It should be understood that this example embodiment is illustrative, and therefore should not be construed as being limiting in any way.

In the example screen display 600G shown in FIG. 6G, the special contact device 120 is illustrated as displaying a home screen 602. While the home screen of the special contact device 120 is substantially similar to the home screen 602 of the user device 102, it should be understood that this example embodiment is illustrative, and therefore should not be construed as being limiting in any way. Because one or more elements of the screen display 600G illustrated in FIG. 6G can be displayed at additional and/or alternative times (e.g., when the special contact device 120 is locked), and because one or more elements of the screen display 600G may or may not be included in all embodiments, it should be understood that the illustrated example embodiment is illustrative and therefore should not be construed as being limiting in any way.

As is illustrated in FIG. 6G, the home screen 602 can include time and/or date information 604; carrier information (not illustrated in FIG. 6G); signal strength information 606 for the primary network connection, which can indicate a strength of a signal associated with the primary network to which the special contact device 120 is connected at the time; a WiFi signal indicator (not shown); battery charge information 608; a direct-to-cell satellite connection indicator 610; the application icons; other information, combinations thereof; or the like. As shown in FIG. 6G, a status of “active” is displayed under the signal strength information 606, thereby indicating that a primary network connection for the special contact device 120, for example a cellular network connection to a terrestrial cellular network, is active at the current time and a status of “backup” is displayed under the direct-to-cell satellite connection indicator 610, thereby indicating that a direct-to-cell satellite connection is active and/or connected at the current time, but is functioning as only a backup network connection for the special contact device 120. It should be understood that this example embodiment is illustrative, and therefore should not be construed as being limiting in any way.

According to various embodiments of the concepts and technologies disclosed herein, the screen display 600G includes another embodiment of the special contact update window 612. In the embodiment shown in FIG. 6G, the special contact update window 612 is illustrated as indicating that the user device 102 (associated with a user named Jake Josephs, a contact of a special contact associated with the special contact device 120) has connected to a limited connectivity direct-to-cell satellite connection, has designated the special contact device as a special contact, and notified the special contact device 120 that a requested communication could not be completed due to the limited connectivity of the user device 102 and asks the special contact device 120 if an alternative form of communication is requested (e.g., a text message, which should be completed). It should be understood that this example embodiment is illustrative, and therefore should not be construed as being limiting in any way.

The special contact update window 612 can include a UI control 614 for entering a “yes” option and a UI control 616 for entering a “no” option. In the embodiment shown in FIG. 6G, selection of the UI control 614 can cause the special contact device 120 to indicate to the coverage management service 114 that the special contact device 120 should send a text message (or request sending a text message) to the user device 102. Selection of the UI control 616 can cause the special contact device 120 to indicate to the coverage management service 114 that that the special contact device 120 should not send a text message to the user device 102. Because the illustrated embodiment of the screen display 600G is illustrative, and because the screen display 600G can include additional and/or alternative information, it should be understood that the embodiment of FIG. 6G is illustrative, and therefore should not be construed as being limiting in any way.

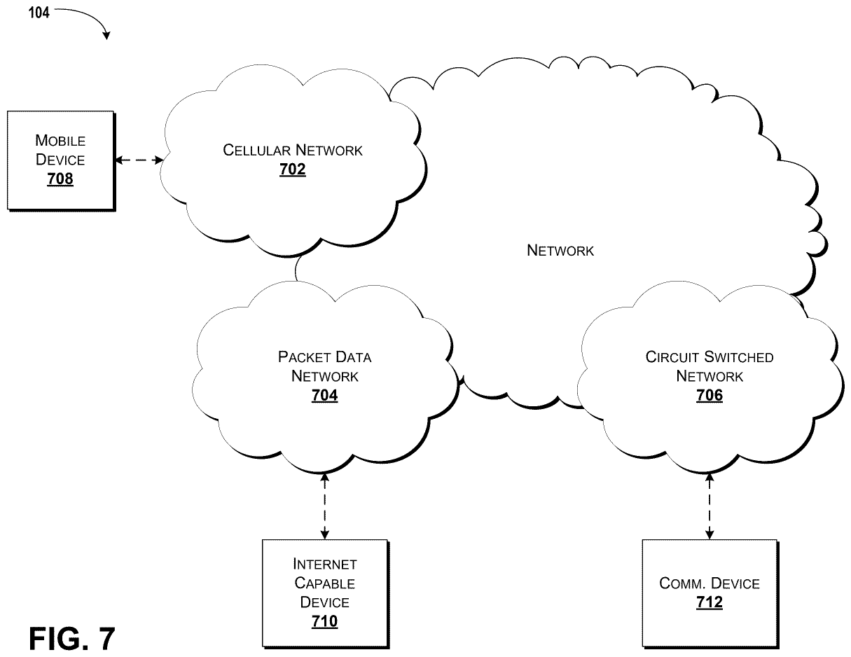

Turning now to FIG. 7, additional details of the network 104 are illustrated, according to an illustrative embodiment. The network 104 includes a cellular network 702, a packet data network 704, for example, the Internet, and a circuit switched network 706, for example, a publicly switched telephone network (“PSTN”). The cellular network 702 includes various components such as, but not limited to, base transceiver stations (“BTSs”), NodeB's or eNodeB's (“eNBs”), gNodeBs (“gNBs”), or the like; base station controllers (“BSCs”) radio network controllers (“RNCs”), or the like; an evolved packet core (“EPC”); mobile switching centers (“MSCs” or “MSSs”); session management functions (“SMFs); mobile management entities (“MMEs”); access and mobility management functions (“AMFs); authentication server functions (“AUSFs”), network slice selection functions (“NSSFs); network exposure functions (“NEFs”); policy control functions (“PCFs”); and various other functions in the user and control planes such as, for example, user plane functions (“UPFs), application functions (“AFs”), NF repository functions (“NRFs”), and the like; short message service centers (“SMSCs”); multimedia messaging service centers (“MMSCs”); home location registers (“HLRs”); home subscriber servers (“HSSs”); visitor location registers (“VLRs”); charging platforms; billing platforms; voicemail platforms; GPRS core network components; links to data networks (“DNs”) and/or other operator services, third party services, and/or the Internet; location service nodes, an IP Multimedia Subsystem (“IMS”); and the like. Of course, the cellular network 702 also can include various interfaces between various components, as is generally understood. The cellular network 702 also includes radios and nodes for receiving and transmitting voice, data, and combinations thereof to and from radio transceivers, networks, the packet data network 704, and the circuit switched network 706.

A mobile communications device 708, such as, for example, a cellular telephone, a user equipment, a mobile terminal, a PDA, a laptop computer, a handheld computer, and combinations thereof, can be operatively connected to the cellular network 702. The cellular network 702 can be configured as a 2G GSM network and can provide data communications via GPRS and/or EDGE. Additionally, or alternatively, the cellular network 702 can be configured as a 3G UMTS network and can provide data communications via the HSPA protocol family, for example, HSDPA, EUL (also referred to as HSUPA), and HSPA+. The cellular network 702 also is compatible with 4G mobile communications standards, 5G mobile communications standards, 6G mobile communication standards, other mobile communications standards, and evolved and future mobile communications standards. Moreover, the cellular network 702 may facilitate communications over various channel access methods (which may or may not be used by the aforementioned standards) including, but not limited to, TDMA, FDMA, W-CDMA, OFDM, SDMA, and the like. In addition, the cellular network 702 may facilitate data communications using GPRS, EDGE, the HSPA protocol family including HSDPA, EUL or otherwise termed HSUPA, HSPA+, and various other current and future wireless data access standards. Because additional and/or alternative mobile communications standards may be used in accordance with various embodiments of the concepts and technologies disclosed herein, it should be understood that these example embodiments are illustrative, and therefore should not be construed as being limiting in any way.

The packet data network 704 includes various devices, for example, servers, computers, databases, and other devices in communication with one another, as is generally known. The packet data network 704 devices are accessible via one or more network links. The servers often store various files that are provided to a requesting device such as, for example, a computer, a terminal, a smartphone, or the like. Typically, the requesting device includes software (a “browser”) for executing a web page in a format readable by the browser or other software. Other files and/or data may be accessible via “links” in the retrieved files, as is generally known. In some embodiments, the packet data network 704 includes or is in communication with the Internet. The circuit switched network 706 includes various hardware and software for providing circuit switched communications. The circuit switched network 706 may include, or may be, what is often referred to as a plain old telephone system (POTS). The functionality of a circuit switched network 706 or other circuit-switched network are generally known and will not be described herein in detail.

The illustrated cellular network 702 is shown in communication with the packet data network 704 and a circuit switched network 706, though it should be appreciated that this is not necessarily the case. One or more Internet-capable devices 710, for example, a PC, a laptop, a portable device, or another suitable device, can communicate with one or more cellular networks 702, and devices connected thereto, through the packet data network 704. It also should be appreciated that the Internet-capable device 710 can communicate with the packet data network 704 through the circuit switched network 706, the cellular network 702, and/or via other networks (not illustrated).

As illustrated, a communications device 712, for example, a telephone, facsimile machine, modem, computer, or the like, can be in communication with the circuit switched network 706, and therethrough to the packet data network 704 and/or the cellular network 702. It should be appreciated that the communications device 712 can be an Internet-capable device, and can be substantially similar to the Internet-capable device 710. In the specification, the network 104 is used to refer broadly to any combination of the networks 702, 704, 706. It should be appreciated that substantially all of the functionality described with reference to the network 104 can be performed by the cellular network 702, the packet data network 704, and/or the circuit switched network 706, alone or in combination with other networks, network elements, and the like.

As explained herein, the network 104 also can include and/or can access a direct-to-cell satellite network (not visible in FIG. 7). As is generally understood, a direct-to-cell satellite network can include one or more satellites (or constellations of satellites), which can be configured to communicate directly with a mobile device such as the user device 102 illustrated and described herein, which as explained herein can include and/or can be similar to the mobile communications device 708 shown in FIG. 7, a vehicle computing system (e.g., a communications device of a connected car system), and/or other devices that can use the direct-to-cell satellite network to bypass terrestrial wireless networks such as the cellular network 702 and/or some components thereof. The satellites of a direct-to-cell satellite network may be located in low earth orbit and therefore the coverage areas CAₛ of satellites of direct-to-cell satellite networks may move relative to the surface of the earth over time. Embodiments of the concepts and technologies disclosed herein can include connectivity to these and other networks as illustrated and described herein.

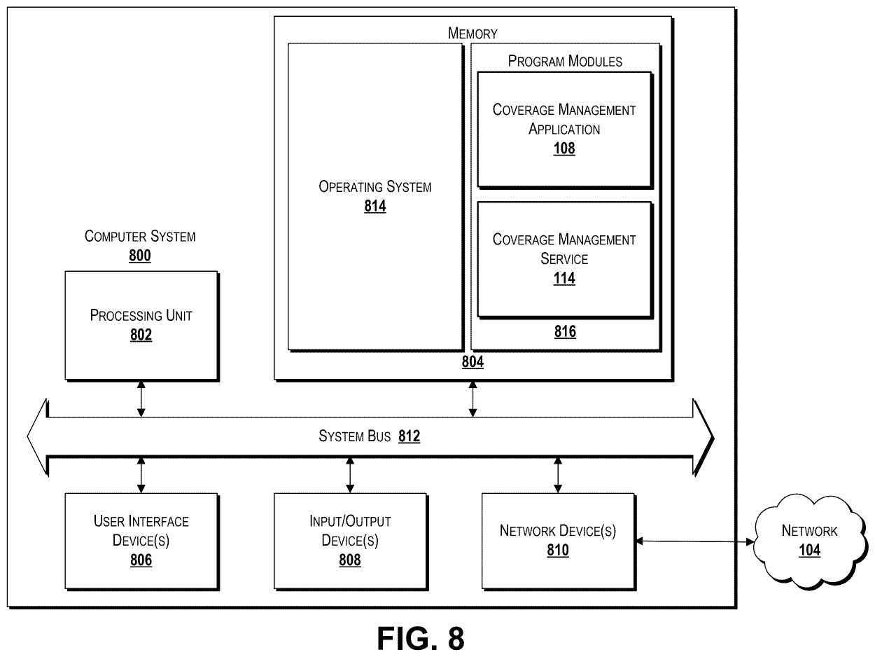

FIG. 8 is a block diagram illustrating a computer system 800 configured to provide the functionality described herein for providing creating and using special contacts for direct-to-cell satellite coverage, in accordance with various embodiments of the concepts and technologies disclosed herein. The computer system 800 includes a processing unit 802, a memory 804, one or more user interface devices 806, one or more input/output (“I/O”) devices 808, and one or more network devices 810, each of which is operatively connected to a system bus 812. The system bus 812 can enable bi-directional communication between the processing unit 802, the memory 804, the user interface devices 806, the I/O devices 808, and the network devices 810.

The processing unit 802 may be a standard central processor that performs arithmetic and logical operations, a more specific purpose programmable logic controller (“PLC”), a programmable gate array, or other type of processor known to those skilled in the art and suitable for controlling the operation of the server computer. As used herein, the word “processor” and/or the phrase “processing unit” when used with regard to any architecture or system can include multiple processors or processing units distributed across and/or operating in parallel in a single machine or in multiple machines. Furthermore, processors and/or processing units can be used to support virtual processing environments. Processors and processing units also can include state machines, application-specific integrated circuits (“ASICs”), combinations thereof, or the like. Because processors and/or processing units are generally known, the processors and processing units disclosed herein will not be described in further detail herein.

The memory 804 communicates with the processing unit 802 via the system bus 812. In some embodiments, the memory 804 is operatively connected to a memory controller (not shown) that enables communication with the processing unit 802 via the system bus 812. The memory 804 includes an operating system 814 and one or more program modules 816. The operating system 814 can include, but is not limited to, members of the WINDOWS, WINDOWS CE, and/or WINDOWS MOBILE families of operating systems from MICROSOFT CORPORATION, the LINUX family of operating systems, the SYMBIAN family of operating systems from SYMBIAN LIMITED, the BREW family of operating systems from QUALCOMM CORPORATION, the MAC OS, iOS, and/or SONOMA families of operating systems from APPLE CORPORATION, the FREEBSD family of operating systems, the SOLARIS family of operating systems from ORACLE CORPORATION, other operating systems, and the like.

The program modules 816 may include various software and/or program modules described herein. In some embodiments, for example, the program modules 816 include the coverage management application 108 and/or the coverage management service 114. These and/or other programs can be embodied in computer-readable media containing instructions that, when executed by the processing unit 802, perform one or more of the methods 200, 300, 400A, 400B, and 500 described in detail above with respect to FIGS. 2-5 and/or other functionality as illustrated and described herein. It can be appreciated that, at least by virtue of the instructions embodying the methods 200, 300, 400A, 400B, 500, and/or other functionality illustrated and described herein being stored in the memory 804 and/or accessed and/or executed by the processing unit 802, the computer system 800 is a special-purpose computing system that can facilitate providing the functionality illustrated and described herein. According to embodiments, the program modules 816 may be embodied in hardware, software, firmware, or any combination thereof. Although not shown in FIG. 8, it should be understood that the memory 804 also can be configured to store the device data 118, the user database 122, the records 126, and/or other data, if desired.

By way of example, and not limitation, computer-readable media may include any available computer storage media or communication media that can be accessed by the computer system 800. Communication media includes computer-readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Computer storage media includes only non-transitory embodiments of computer readable media as illustrated and described herein. Thus, computer storage media can include volatile and non-volatile, removable and non-removable media implemented in any method or technology for storage of information such as computer-readable instructions, data structures, program modules, or other data. Computer storage media includes, but is not limited to, RAM, ROM, Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium which can be used to store the desired information and which can be accessed by the computer system 800. In the claims, the phrase “computer storage medium” and variations thereof does not include waves or signals per se and/or communication media.

The user interface devices 806 may include one or more devices with which a user accesses the computer system 800. The user interface devices 806 may include, but are not limited to, computers, servers, personal digital assistants, cellular phones, or any suitable computing devices. The I/O devices 808 enable a user to interface with the program modules 816. In one embodiment, the I/O devices 808 are operatively connected to an I/O controller (not shown) that enables communication with the processing unit 802 via the system bus 812. The I/O devices 808 may include one or more input devices, such as, but not limited to, a keyboard, a mouse, or an electronic stylus. Further, the I/O devices 808 may include one or more output devices, such as, but not limited to, a display screen or a printer.

The network devices 810 enable the computer system 800 to communicate with other networks or remote systems via a network, such as the network 104. Examples of the network devices 810 include, but are not limited to, a modem, a radio frequency (“RF”) or infrared (“IR”) transceiver, a telephonic interface, a bridge, a router, or a network card. The network 104 may include a wireless network such as, but not limited to, a Wireless Local Area Network (“WLAN”) such as a WI-FI network, a Wireless Wide Area Network (“WWAN”), a Wireless Personal Area Network (“WPAN”) such as BLUETOOTH, a Wireless Metropolitan Area Network (“WMAN”) such as a WiMAX network, or a cellular network. Alternatively, the network 104 may be a wired network such as, but not limited to, a Wide Area Network (“WAN”) such as the Internet, a Local Area Network (“LAN”) such as the Ethernet, a wired Personal Area Network (“PAN”), or a wired Metropolitan Area Network (“MAN”).

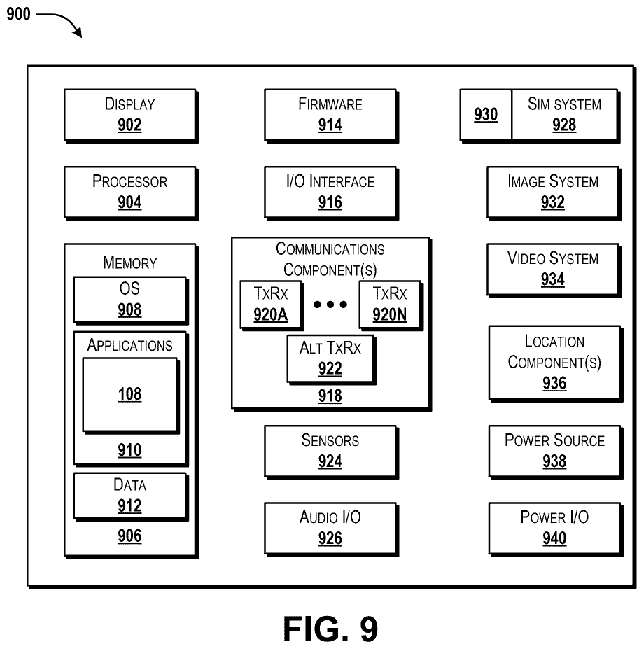

Turning now to FIG. 9, an illustrative mobile device 900 and components thereof will be described. In some embodiments, the user device 102 described above with reference to FIGS. 1-6G can be configured as and/or can have an architecture similar or identical to the mobile device 900 described herein in FIG. 9. It should be understood, however, that the user device 102 may or may not include the functionality described herein with reference to FIG. 9. While connections are not shown between the various components illustrated in FIG. 9, it should be understood that some, none, or all of the components illustrated in FIG. 9 can be configured to interact with one another to carry out various device functions. In some embodiments, the components are arranged so as to communicate via one or more busses (not shown). Thus, it should be understood that FIG. 9 and the following description are intended to provide a general understanding of a suitable environment in which various aspects of embodiments can be implemented, and should not be construed as being limiting in any way.

As illustrated in FIG. 9, the mobile device 900 can include a display 902 for displaying data. According to various embodiments, the display 902 can be configured to display various graphical user interface (“GUI”) elements such as, for example, elements for indicating one or more active or available network connections, time until a network connection will be available, costs for using a network connection, limitations of a network connection, a status of network connection (e.g., active, inactive, available, unavailable, primary, secondary, etc.), text, images, video, virtual keypads and/or keyboards, messaging data, notification messages, metadata, internet content, device status, time, date, calendar data, device preferences, map and location data, combinations thereof, and/or the like. The mobile device 900 also can include a processor 904 and a memory or other data storage device (“memory”) 906. The processor 904 can be configured to process data and/or can execute computer-executable instructions stored in the memory 906. The computer-executable instructions executed by the processor 904 can include, for example, an operating system 908, one or more applications 910 such as the coverage management application 108, the coverage management service 114, other computer-executable instructions stored in a memory 906, or the like. In some embodiments, the applications 910 also can include a UI application (not illustrated in FIG. 9).

The UI application can interface with the operating system 908, such as the operating system 106 shown in FIG. 1, to facilitate user interaction with functionality and/or data stored at the mobile device 900 and/or stored elsewhere. In some embodiments, the operating system 908 can include a member of the SYMBIAN OS family of operating systems from SYMBIAN LIMITED, a member of the WINDOWS MOBILE OS and/or WINDOWS PHONE OS families of operating systems from MICROSOFT CORPORATION, a member of the PALM WEBOS family of operating systems from HEWLETT PACKARD CORPORATION, a member of the BLACKBERRY OS family of operating systems from RESEARCH IN MOTION LIMITED, a member of the IOS family of operating systems from APPLE INC., a member of the ANDROID OS family of operating systems from GOOGLE INC., and/or other operating systems. These operating systems are merely illustrative of some contemplated operating systems that may be used in accordance with various embodiments of the concepts and technologies described herein and therefore should not be construed as being limiting in any way.

The UI application can be executed by the processor 904 to aid a user in entering content, providing network connection status and details, configuring settings, manipulating address book content and/or settings, multimode interaction, interacting with other applications 910, and otherwise facilitating user interaction with the operating system 908, the applications 910, and/or other types or instances of data 912 that can be stored at the mobile device 900. The data 912 can include, for example, the coverage management application 108, the coverage management service 114, and/or other applications or program modules. According to various embodiments, the data 912 can include, for example, presence applications, visual voice mail applications, messaging applications, text-to-speech and speech-to-text applications, add-ons, plug-ins, email applications, music applications, video applications, camera applications, location-based service applications, power conservation applications, game applications, productivity applications, entertainment applications, enterprise applications, combinations thereof, and the like. The applications 910, the data 912, and/or portions thereof can be stored in the memory 906 and/or in a firmware 914, and can be executed by the processor 904.

It can be appreciated that, at least by virtue of storage of the instructions corresponding to the applications 910 and/or other instructions embodying other functionality illustrated and described herein in the memory 906, and/or by virtue of the instructions corresponding to the applications 910 and/or other instructions embodying other functionality illustrated and described herein being accessed and/or executed by the processor 904, the mobile device 900 is a special-purpose mobile device that can facilitate providing the functionality illustrated and described herein. The firmware 914 also can store code for execution during device power up and power down operations. It can be appreciated that the firmware 914 can be stored in a volatile or non-volatile data storage device including, but not limited to, the memory 906 and/or a portion thereof.

The mobile device 900 also can include an input/output (“I/O”) interface 916. The I/O interface 916 can be configured to support the input/output of data such as location information, history information, location information, contact information, identity data, special contacts, preferences, the device data 118, the user database 122, the records 126, user information, organization information, presence status information, user IDs, passwords, and application initiation (start-up) requests. In some embodiments, the I/O interface 916 can include a hardwire connection such as a universal serial bus (“USB”) port, a mini-USB port, a micro-USB port, an audio jack, a PS2 port, an IEEE 1394 (“FIREWIRE”) port, a serial port, a parallel port, an Ethernet (RJ45 or RJ48) port, a telephone (RJ11 or the like) port, a proprietary port, combinations thereof, or the like. In some embodiments, the mobile device 900 can be configured to synchronize with another device to transfer content to and/or from the mobile device 900. In some embodiments, the mobile device 900 can be configured to receive updates to one or more of the applications 910 via the I/O interface 916, though this is not necessarily the case. In some embodiments, the I/O interface 916 accepts I/O devices such as keyboards, keypads, mice, interface tethers, printers, plotters, external storage, touch/multi-touch screens, touch pads, trackballs, joysticks, microphones, remote control devices, displays, projectors, medical equipment (e.g., stethoscopes, heart monitors, and other health metric monitors), modems, routers, external power sources, docking stations, combinations thereof, and the like. It should be appreciated that the I/O interface 916 may be used for communications between the mobile device 900 and a network device or local device.

The mobile device 900 also can include a communications component 918. The communications component 918 can be configured to interface with the processor 904 to facilitate wired and/or wireless communications with one or more networks such as the network 104, the direct-to-cell satellite network 110, the wireless network 112, and/or the local network 999 described herein. In some embodiments, other networks include networks that utilize non-cellular wireless technologies such as WI-FI or WIMAX. In some embodiments, the communications component 918 includes a multimode communications subsystem for facilitating communications via the cellular network and one or more other networks.

The communications component 918, in some embodiments, includes one or more transceivers. The one or more transceivers, if included, can be configured to communicate over the same and/or different wireless technology standards with respect to one another. For example, in some embodiments one or more of the transceivers of the communications component 918 may be configured to communicate using GSM, CDMAONE, CDMA2000, LTE, and various other 2G, 2.5G, 3G, 4G, 5G, 6G, and greater generation technology standards. Moreover, the communications component 918 may facilitate communications over various channel access methods (which may or may not be used by the aforementioned standards) including, but not limited to, TDMA, FDMA, W-CDMA, OFDM, SDMA, and the like.

In addition, the communications component 918 may facilitate data communications using GPRS, EDGE, the HSPA protocol family including HSDPA, EUL or otherwise termed HSUPA, HSPA+, and various other current and future wireless data access standards. In the illustrated embodiment, the communications component 918 can include a first transceiver (“TxRx”) 920A that can operate in a first communications mode (e.g., GSM). The communications component 918 also can include an Nt^{h} transceiver (“TxRx”) 920N that can operate in a second communications mode relative to the first transceiver 920A (e.g., UMTS). While two transceivers 920A-N (hereinafter collectively and/or generically referred to as “transceivers 920”) are shown in FIG. 9, it should be appreciated that less than two, two, and/or more than two transceivers 920 can be included in the communications component 918.

The communications component 918 also can include an alternative transceiver (“Alt TxRx”) 922 for supporting other types and/or standards of communications. According to various contemplated embodiments, the alternative transceiver 922 can communicate using various communications technologies such as, for example, WI-FI, WIMAX, BLUETOOTH, infrared, infrared data association (“IRDA”), near field communications (“NFC”), other RF technologies, combinations thereof, and the like. In some embodiments, the communications component 918 also can facilitate reception from terrestrial radio networks, digital satellite radio networks, internet-based radio service networks, combinations thereof, and the like. The communications component 918 can process data from a network such as the Internet, an intranet, a broadband network, a WI-FI hotspot, an Internet service provider (“ISP”), a digital subscriber line (“DSL”) provider, a broadband provider, combinations thereof, or the like.

The mobile device 900 also can include one or more sensors 924. The sensors 924 can include temperature sensors, light sensors, air quality sensors, movement sensors, orientation sensors, noise sensors, proximity sensors, or the like. As such, it should be understood that the sensors 924 can include, but are not limited to, accelerometers, magnetometers, gyroscopes, infrared sensors, noise sensors, microphones, combinations thereof, or the like. Additionally, audio capabilities for the mobile device 900 may be provided by an audio I/O component 926. The audio I/O component 926 of the mobile device 900 can include one or more speakers for the output of audio signals, one or more microphones for the collection and/or input of audio signals, and/or other audio input and/or output devices.

The illustrated mobile device 900 also can include a subscriber identity module (“SIM”) system 928. The SIM system 928 can include a universal SIM (“USIM”), a universal integrated circuit card (“UICC”) and/or other identity devices. The SIM system 928 can include and/or can be connected to or inserted into an interface such as a slot interface 930. In some embodiments, the slot interface 930 can be configured to accept insertion of other identity cards or modules for accessing various types of networks. Additionally, or alternatively, the slot interface 930 can be configured to accept multiple subscriber identity cards. Because other devices and/or modules for identifying users and/or the mobile device 900 are contemplated, it should be understood that these embodiments are illustrative, and should not be construed as being limiting in any way.

The mobile device 900 also can include an image capture and processing system 932 (“image system”). The image system 932 can be configured to capture or otherwise obtain photos, videos, and/or other visual information. As such, the image system 932 can include cameras, lenses, charge-coupled devices (“CCDs”), combinations thereof, or the like. The mobile device 900 may also include a video system 934. The video system 934 can be configured to capture, process, record, modify, and/or store video content. Photos and videos obtained using the image system 932 and the video system 934, respectively, may be added as message content to an MMS message, email message, and sent to another mobile device. The video and/or photo content also can be shared with other devices via various types of data transfers via wired and/or wireless communication devices as described herein.

The mobile device 900 also can include one or more location components 936. The location components 936 can be configured to send and/or receive signals to determine a geographic location of the mobile device 900. According to various embodiments, the location components 936 can send and/or receive signals from global positioning system (“GPS”) devices, assisted-GPS (“A-GPS”) devices, WI-FI/WIMAX and/or cellular network triangulation data, combinations thereof, and the like. The location component 936 also can be configured to communicate with the communications component 918 to retrieve triangulation data for determining a location of the mobile device 900. In some embodiments, the location component 936 can interface with cellular network nodes, telephone lines, satellites, location transmitters and/or beacons, wireless network transmitters and receivers, combinations thereof, and the like. In some embodiments, the location component 936 can include and/or can communicate with one or more of the sensors 924 such as a compass, an accelerometer, and/or a gyroscope to determine the orientation of the mobile device 900. Using the location component 936, the mobile device 900 can generate and/or receive data to identify its geographic location, or to transmit data used by other devices to determine the location of the mobile device 900. The location component 936 may include multiple components for determining the location and/or orientation of the mobile device 900.

The illustrated mobile device 900 also can include a power source 938. The power source 938 can include one or more batteries, power supplies, power cells, and/or other power subsystems including alternating current (“AC”) and/or direct current (“DC”) power devices. The power source 938 also can interface with an external power system or charging equipment via a power I/O component 940. Because the mobile device 900 can include additional and/or alternative components, the above embodiment should be understood as being illustrative of one possible operating environment for various embodiments of the concepts and technologies described herein. The described embodiment of the mobile device 900 is illustrative, and should not be construed as being limiting in any way.

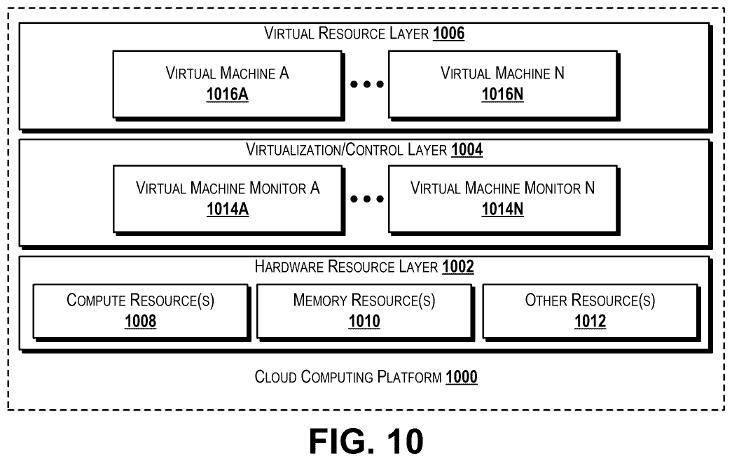

FIG. 10 illustrates an illustrative architecture for a cloud computing platform 1000 that can be capable of executing the software components described herein for providing creating and using special contacts for direct-to-cell satellite coverage and/or for interacting with the coverage management application 108 and/or the coverage management service 114. Thus, it can be appreciated that in some embodiments of the concepts and technologies disclosed herein, the cloud computing platform 1000 illustrated in FIG. 10 can be used to provide the functionality described herein with respect to the user device 102, the server computer 116, the special contact device 120, and/or the data store 124.

The cloud computing platform 1000 thus may be utilized to execute any aspects of the software components presented herein. Thus, according to various embodiments of the concepts and technologies disclosed herein, the coverage management application 108 and/or the coverage management service 114 can be implemented, at least in part, on or by elements included in the cloud computing platform 1000 illustrated and described herein. Those skilled in the art will appreciate that the illustrated cloud computing platform 1000 is a simplification of but only one possible implementation of an illustrative cloud computing platform, and as such, the illustrated cloud computing platform 1000 should not be construed as being limiting in any way.

In the illustrated embodiment, the cloud computing platform 1000 can include a hardware resource layer 1002, a virtualization/control layer 1004, and a virtual resource layer 1006. These layers and/or other layers can be configured to cooperate with each other and/or other elements of a cloud computing platform 1000 to perform operations as will be described in detail herein. While connections are shown between some of the components illustrated in FIG. 10, it should be understood that some, none, or all of the components illustrated in FIG. 10 can be configured to interact with one another to carry out various functions described herein. In some embodiments, the components are arranged so as to communicate via one or more networks such as, for example, the network 104 illustrated and described hereinabove (not shown in FIG. 10). Thus, it should be understood that FIG. 10 and the following description are intended to provide a general understanding of a suitable environment in which various aspects of embodiments can be implemented, and should not be construed as being limiting in any way.

The hardware resource layer 1002 can provide hardware resources. In the illustrated embodiment, the hardware resources can include one or more compute resources 1008, one or more memory resources 1010, and one or more other resources 1012. The compute resource(s) 1008 can include one or more hardware components that can perform computations to process data, and/or to execute computer-executable instructions of one or more application programs, operating systems, services, and/or other software including, but not limited to, the coverage management application 108 and/or the coverage management service 114 illustrated and described herein.

According to various embodiments, the compute resources 1008 can include one or more central processing units (“CPUs”). The CPUs can be configured with one or more processing cores. In some embodiments, the compute resources 1008 can include one or more graphics processing units (“GPUs”). The GPUs can be configured to accelerate operations performed by one or more CPUs, and/or to perform computations to process data, and/or to execute computer-executable instructions of one or more application programs, operating systems, and/or other software that may or may not include instructions that are specifically graphics computations and/or related to graphics computations. In some embodiments, the compute resources 1008 can include one or more discrete GPUs. In some other embodiments, the compute resources 1008 can include one or more CPU and/or GPU components that can be configured in accordance with a co-processing CPU/GPU computing model. Thus, it can be appreciated that in some embodiments of the compute resources 1008, a sequential part of an application can execute on a CPU and a computationally-intensive part of the application can be accelerated by the GPU. It should be understood that this example is illustrative, and therefore should not be construed as being limiting in any way.

In some embodiments, the compute resources 1008 also can include one or more system on a chip (“SoC”) components. It should be understood that an SoC component can operate in association with one or more other components as illustrated and described herein, for example, one or more of the memory resources 1010 and/or one or more of the other resources 1012. In some embodiments in which an SoC component is included, the compute resources 1008 can be or can include one or more embodiments of the SNAPDRAGON brand family of SoCs, available from QUALCOMM of San Diego, California; one or more embodiment of the TEGRA brand family of SoCs, available from NVIDIA of Santa Clara, California; one or more embodiment of the HUMMINGBIRD brand family of SoCs, available from SAMSUNG of Seoul, South Korea; one or more embodiment of the Open Multimedia Application Platform (“OMAP”) family of SoCs, available from TEXAS INSTRUMENTS of Dallas, Texas; one or more customized versions of any of the above SoCs; and/or one or more other brand and/or one or more proprietary SoCs.

The compute resources 1008 can be or can include one or more hardware components arranged in accordance with an ARM architecture, available for license from ARM HOLDINGS of Cambridge, United Kingdom. Alternatively, the compute resources 1008 can be or can include one or more hardware components arranged in accordance with an x86 architecture, such as an architecture available from INTEL CORPORATION of Mountain View, California, and others. Those skilled in the art will appreciate the implementation of the compute resources 1008 can utilize various computation architectures and/or processing architectures. As such, the various example embodiments of the compute resources 1008 as mentioned hereinabove should not be construed as being limiting in any way. Rather, implementations of embodiments of the concepts and technologies disclosed herein can be implemented using compute resources 1008 having any of the particular computation architecture and/or combination of computation architectures mentioned herein as well as other architectures.

Although not separately illustrated in FIG. 10, it should be understood that the compute resources 1008 illustrated and described herein can host and/or execute various services, applications, portals, and/or other functionality illustrated and described herein. Thus, the compute resources 1008 can host and/or can execute the coverage management application 108, the coverage management service 114, or other applications or services illustrated and described herein.

The memory resource(s) 1010 can include one or more hardware components that can perform or provide storage operations, including temporary and/or permanent storage operations. In some embodiments, the memory resource(s) 1010 can include volatile and/or non-volatile memory implemented in any method or technology for storage of information such as computer-readable instructions, data structures, program modules, or other data disclosed herein. Computer storage media is defined hereinabove and therefore should be understood as including, in various embodiments, random access memory (“RAM”), read-only memory (“ROM”), Erasable Programmable ROM (“EPROM”), Electrically Erasable Programmable ROM (“EEPROM”), flash memory or other solid state memory technology, CD-ROM, digital versatile disks (“DVD”), or other optical storage, magnetic cassettes, magnetic tape, magnetic disk storage or other magnetic storage devices, or any other medium that can be used to store data and that can be accessed by the compute resources 1008, subject to the definition of “computer storage media” provided above (e.g., as excluding waves and signals per se and/or communication media as defined in this application).

Although not illustrated in FIG. 10, it should be understood that the memory resources 1010 can host or store the various data illustrated and described herein including, but not limited to, the device data 118, the user database 122, the records 126, and/or other data, if desired. It should be understood that this example is illustrative, and therefore should not be construed as being limiting in any way. The other resource(s) 1012 can include any other hardware resources that can be utilized by the compute resources(s) 1008 and/or the memory resource(s) 1010 to perform operations. The other resource(s) 1012 can include one or more input and/or output processors (e.g., a network interface controller and/or a wireless radio), one or more modems, one or more codec chipsets, one or more pipeline processors, one or more fast Fourier transform (“FFT”) processors, one or more digital signal processors (“DSPs”), one or more speech synthesizers, combinations thereof, or the like.

The hardware resources operating within the hardware resource layer 1002 can be virtualized by one or more virtual machine monitors (“VMMs”) 1014A-1014N (also known as “hypervisors;” hereinafter “VMMs 1014”). The VMMs 1014 can operate within the virtualization/control layer 1004 to manage one or more virtual resources that can reside in the virtual resource layer 1006. The VMMs 1014 can be or can include software, firmware, and/or hardware that alone or in combination with other software, firmware, and/or hardware, can manage one or more virtual resources operating within the virtual resource layer 1006.

The virtual resources operating within the virtual resource layer 1006 can include abstractions of at least a portion of the compute resources 1008, the memory resources 1010, the other resources 1012, or any combination thereof. These abstractions are referred to herein as virtual machines (“VMs”). In the illustrated embodiment, the virtual resource layer 1006 includes VMs 1016A-1016N (hereinafter “VMs 1016”).

Based on the foregoing, it should be appreciated that systems and methods for providing creating and using special contacts for direct-to-cell satellite coverage have been disclosed herein. Although the subject matter presented herein has been described in language specific to computer structural features, methodological and transformative acts, specific computing machinery, and computer-readable media, it is to be understood that the concepts and technologies disclosed herein are not necessarily limited to the specific features, acts, or media described herein. Rather, the specific features, acts and mediums are disclosed as example forms of implementing the concepts and technologies disclosed herein.

The subject matter described above is provided by way of illustration only and should not be construed as limiting. Various modifications and changes may be made to the subject matter described herein without following the example embodiments and applications illustrated and described, and without departing from the true spirit and scope of the embodiments of the concepts and technologies disclosed herein.

1. A system comprising:
a processor; and
a memory that stores computer-executable instructions that, when executed by the processor, cause the processor to perform operations comprising
obtaining device data associated with a user device, wherein the device data comprises identity data that identifies the user device and connection data that identifies a current network connection of the user device, wherein the connection data indicates that the user device currently has limited network connectivity and is connected to a direct-to-cell satellite network connection;
obtaining a record associated with the user device, where the record is stored in a user database and comprises special contacts information that identifies a special contact for the user device, wherein the special contact comprises a contact that is to be updated when the user device has the limited network connectivity and is connected to the direct-to-cell satellite network connection;
determining, based on the record associated with the user device, notification preferences associated with the user device, the notification preferences defining how the special contact is to be updated when the user device has the limited network connectivity and is connected to the direct-to-cell satellite network connection; and
managing, based on the notification preferences, communications with a special contact device associated with the special contact regarding the user device.

2. The system of claim 1, wherein managing the communications comprises:
in response to determining that proactive alerts are to be provided to the special contact device, generating an alert and triggering delivery of the alert to the special contact device, wherein the alert indicates that the user device has the limited network connectivity and is connected to the direct-to-cell satellite network connection.

3. The system of claim 1, wherein managing the communications comprises:
in response to determining that the special contact device has attempted to contact the user device while the user device has the limited network connectivity and is connected to the direct-to-cell satellite network connection, generating an alert and triggering delivery of the alert to the special contact device, wherein the alert indicates that the user device has the limited network connectivity and is connected to the direct-to-cell satellite network connection.

4. The system of claim 1, wherein managing the communications comprises:
in response to determining that the special contact device has attempted to contact the user device while the user device has the limited network connectivity and is connected to the direct-to-cell satellite network connection, generating an alert and triggering delivery of the alert to the user device, wherein the alert indicates that the user device has the limited network connectivity and that the special contact device has attempted to contact the user device, and wherein the alert includes an option to automatically establish a communication between the special contact device and the user device when the user device connects to a network connection other than the direct-to-cell satellite network connection; and
in response to determining that the user device has connected to the network connection other than the direct-to-cell satellite network connection, triggering establishment of the communication between the special contact device and the user device.

5. The system of claim 1, wherein managing the communications comprises:
obtaining, from the user device, history data that comprises a first time, a first geographic location at which the user device is located, and a first indication that the user device is connected to the direct-to-cell satellite network connection; and
updating the record based on the history data.

6. The system of claim 1, wherein managing the communications comprises:
obtaining, from the user device, history data that comprises a first time, a first geographic location at which the user device is located, and a first indication that the user device is connected to the direct-to-cell satellite network connection;
updating the record based on a tracking history of the user device, wherein the tracking history is defined by the history data; and
in response to determining, based on the record, that the tracking history is to be shared with the special contact, sending to the special contact device a further alert with a link via which the special contact device can access the tracking history.

7. The system of claim 1, wherein the computer-executable instructions, when executed by the processor, cause the processor to perform operations further comprising:
updating, at the user device, a user interface that indicates that the user device has the limited network connectivity and is connected to the direct-to-cell satellite network connection, and an option to share data identifying the current network connection of the user device with the special contact device.

8. A method comprising:
obtaining, at a server computer comprising a processor, device data associated with a user device, wherein the device data comprises identity data that identifies the user device and connection data that identifies a current network connection of the user device, wherein the connection data indicates that the user device currently has limited network connectivity and is connected to a direct-to-cell satellite network connection;
obtaining, by the processor, a record associated with the user device, where the record is stored in a user database and comprises special contacts information that identifies a special contact for the user device, wherein the special contact comprises a contact that is to be updated when the user device has the limited network connectivity and is connected to the direct-to-cell satellite network connection;
determining, by the processor and based on the record associated with the user device, notification preferences associated with the user device, the notification preferences defining how the special contact is to be updated when the user device has the limited network connectivity and is connected to the direct-to-cell satellite network connection; and
managing, by the processor and based on the notification preferences, communications with a special contact device associated with the special contact regarding the user device.

9. The method of claim 8, wherein managing the communications comprises:
in response to determining that proactive alerts are to be provided to the special contact device, generating an alert and triggering delivery of the alert to the special contact device, wherein the alert indicates that the user device has the limited network connectivity and is connected to the direct-to-cell satellite network connection.

10. The method of claim 8, wherein managing the communications comprises:
in response to determining that the special contact device has attempted to contact the user device while the user device has the limited network connectivity and is connected to the direct-to-cell satellite network connection, generating an alert and triggering delivery of the alert to the special contact device, wherein the alert indicates that the user device has the limited network connectivity and is connected to the direct-to-cell satellite network connection.

11. The method of claim 8, wherein managing the communications comprises:
in response to determining that the special contact device has attempted to contact the user device while the user device has the limited network connectivity and is connected to the direct-to-cell satellite network connection, generating an alert and triggering delivery of the alert to the user device, wherein the alert indicates that the user device has the limited network connectivity and that the special contact device has attempted to contact the user device, and wherein the alert includes an option to automatically establish a communication between the special contact device and the user device when the user device connects to a network connection other than the direct-to-cell satellite network connection; and
in response to determining that the user device has connected to the network connection other than the direct-to-cell satellite network connection, triggering establishment of the communication between the special contact device and the user device.

12. The method of claim 8, wherein managing the communications comprises:
obtaining, from the user device, history data that comprises a first time, a first geographic location at which the user device is located, and a first indication that the user device is connected to the direct-to-cell satellite network connection; and
updating the record based on the history data.

13. The method of claim 8, wherein managing the communications comprises:
obtaining, from the user device, history data that comprises a first time, a first geographic location at which the user device is located, and a first indication that the user device is connected to the direct-to-cell satellite network connection;
updating the record based on a tracking history of the user device, wherein the tracking history is defined by the history data; and
in response to determining, based on the record, that the tracking history is to be shared with the special contact, sending to the special contact device a further alert with a link via which the special contact device can access the tracking history.

14. A computer storage medium having computer-executable instructions stored thereon that, when executed by a processor, cause the processor to perform operations comprising:
obtaining device data associated with a user device, wherein the device data comprises identity data that identifies the user device and connection data that identifies a current network connection of the user device, wherein the connection data indicates that the user device currently has limited network connectivity and is connected to a direct-to-cell satellite network connection;
obtaining a record associated with the user device, where the record is stored in a user database and comprises special contacts information that identifies a special contact for the user device, wherein the special contact comprises a contact that is to be updated when the user device has the limited network connectivity and is connected to the direct-to-cell satellite network connection;
determining, based on the record associated with the user device, notification preferences associated with the user device, the notification preferences defining how the special contact is to be updated when the user device has the limited network connectivity and is connected to the direct-to-cell satellite network connection; and
managing, based on the notification preferences, communications with a special contact device associated with the special contact regarding the user device.

15. The computer storage medium of claim 14, wherein managing the communications comprises:
in response to determining that proactive alerts are to be provided to the special contact device, generating an alert and triggering delivery of the alert to the special contact device, wherein the alert indicates that the user device has the limited network connectivity and is connected to the direct-to-cell satellite network connection.

16. The computer storage medium of claim 14, wherein managing the communications comprises:
in response to determining that the special contact device has attempted to contact the user device while the user device has the limited network connectivity and is connected to the direct-to-cell satellite network connection, generating an alert and triggering delivery of the alert to the special contact device, wherein the alert indicates that the user device has the limited network connectivity and is connected to the direct-to-cell satellite network connection.

17. The computer storage medium of claim 14, wherein managing the communications comprises:
in response to determining that the special contact device has attempted to contact the user device while the user device has the limited network connectivity and is connected to the direct-to-cell satellite network connection, generating an alert and triggering delivery of the alert to the user device, wherein the alert indicates that the user device has the limited network connectivity and that the special contact device has attempted to contact the user device, and wherein the alert includes an option to automatically establish a communication between the special contact device and the user device when the user device connects to a network connection other than the direct-to-cell satellite network connection; and
in response to determining that the user device has connected to the network connection other than the direct-to-cell satellite network connection, triggering establishment of the communication between the special contact device and the user device.

18. The computer storage medium of claim 14, wherein managing the communications comprises:
obtaining, from the user device, history data that comprises a first time, a first geographic location at which the user device is located, and a first indication that the user device is connected to the direct-to-cell satellite network connection; and
updating the record based on the history data.

19. The computer storage medium of claim 14, wherein managing the communications comprises:
obtaining, from the user device, history data that comprises a first time, a first geographic location at which the user device is located, and a first indication that the user device is connected to the direct-to-cell satellite network connection;
updating the record based on a tracking history of the user device, wherein the tracking history is defined by the history data; and
in response to determining, based on the record, that the tracking history is to be shared with the special contact, sending to the special contact device a further alert with a link via which the special contact device can access the tracking history.

20. The computer storage medium of claim 14, wherein the computer-executable instructions, when executed by the processor, cause the processor to perform operations further comprising:
updating, at the user device, a user interface that indicates that the user device has the limited network connectivity and is connected to the direct-to-cell satellite network connection, and an option to share data identifying the current network connection of the user device with the special contact device.
